(19) United States
(12) Patent Application Publication
(10) Pub. No.: US 2012/0173502 A1
(43) Pub. Date: Jul. 5, 2012

(54) SYSTEM AND METHOD FOR DISPLAYING, ENABLING EXPLORATION AND DISCOVERY, RECOMMENDING, AND PLAYING BACK MEDIA FILES BASED ON USER PREFERENCES

(76) Inventors: Harsha Prem Kumar, Norwalk, CT (US); Jayendranath Krishnamoorthy, East Haven, CT (US); Hema Sastry, Norwalk, CT (US)

(21) Appl. No.: 13/291,885

(22) Filed: Nov. 8, 2011

Related U.S. Application Data
(60) Provisional application No. 61/411,519, filed on Nov. 9, 2010.
(60) Provisional application No. 61/445,939, filed on Feb. 23, 2011.

(51) Int. Cl. G06F 17/30

(52) U.S. Cl. 707/706; 707/769; 707/766; 707/E17.014; 707/E17.108

(57) ABSTRACT

Methods, systems, electronic displays, and computer-readable storage devices for displaying media files can include a search entry field displaying an active search query defining parameters of a playlist identifying one or more media files satisfying the parameters. A playback indicator displaying information related to a selected media file from the playlist can be included. Category indicators can be included that each display a distinct media category associated with the playlist. The parameters of the playlist can be defined by at least one attribute of a media category that is not displayed by the category indicators. One or more selectable attribute indicators can be included, and each can display an attribute of a media category associated with one of the media category indicators. Selecting an attribute indicator can modify the active search query, thereby further defining the parameters of the playlist and automatically updating the playlist in real time.

### RELATED APPLICATIONS

This application claims priority to, and the benefit of, co-pending U.S. Provisional Application No. 61/411,519, filed Nov. 9, 2010 for all subject matter common to both applications. This application also claims priority to, and the benefit of, co-pending U.S. Provisional Application No. 61/445,939, filed Feb. 23, 2011, for all subject matter common to both applications. The disclosures of said provisional applications are hereby incorporated by reference in their entirety.

### FIELD OF THE INVENTION

The present invention relates to displays and search features suitable for generating a play list for a user. More particularly, the present invention relates to a system and method for generating and displaying play lists to a user based on one or more user preferences.

### BACKGROUND OF THE INVENTION

Many internet radios and other websites exist to offer music or other recommendations to users. In some instances, users accessing such websites can enter and submit artist(s) or a musical style, upon which a play list of songs is generated that offers the user music related to the user's entry. In other instances, users can create play lists “manually,” i.e., by adding desired songs to the play list one at a time (or by adding sets of songs, such as an entire album).

Such systems suffer from several drawbacks. For one, for many users find it inconvenient and burdensome to manually generate desired play lists. Additionally, such play lists are not suitable for recommending new music to users. Furthermore, play lists requiring manual generation can only contain static, unchanging lists of songs. This results in the element of surprise being limited to the random order that is created by using a shuffle feature.

Furthermore, for systems offering automatically generated play lists, the songs contained therein are based on associations being made by musical experts and subsequently programmed into the system. Such associations are often limited in a number of ways. For example, what constitutes similarity between songs is subject to debate. Additionally, a single song is made up of many different features, characteristics, and attributes. Thus, two songs simultaneously can be both similar and dissimilar, depending on the particular attribute or type of characteristic in question.

Therefore, the judgments of musical experts inherently make choices regarding which particular characteristics should serve as the basis for drawing associations between songs. In many instances, users simply may disagree about which characteristics are most important when determining song similarity. Furthermore, a given user's preferences regarding which characteristic is “most important” for determining song similarly can change from time to time. Such changes are not accommodated by systems that offer fixed associations between songs.

For at least these reasons, existing systems fail to provide users with automatically generated recommendations for songs that directly cater to the particular application/use and/or the particular mood of the user.

### SUMMARY

There is a need for a media file exploration, discovery, recommendation, and playback system that provides users with greater flexibility, quicker response, and enhanced control. Additionally, there is a need for a system that allows users to determine the particular qualities for automatically creating associations between songs. Embodiments of the present invention are directed toward further solutions to address these needs, in addition to having other desirable characteristics.

In accordance with example embodiments of the present invention, a computer implemented display for media files can include a search entry field displaying an active search query defining parameters of a play list identifying one or more media files satisfying the parameters. A playback indicator can display information related to a selected media file from the play list. A plurality of category indicators each can display a distinct media category associated with the play list. The parameters of the play list can be defined by at least one attribute of a media category that is not displayed by any of the plurality of category indicators.

In accordance with example embodiments of the present invention, one or more selectable attribute indicators each can display an attribute of a media category associated with one of the plurality of media category indicators. Selecting (e.g., and submitting) an attribute indicator can active search query to be modified, thereby further defining the parameters of the play list and automatically updating the play list in real time. The one or more selectable attribute indicators can be configured to only display attributes that are associated with media files in the play list. The plurality of category indicators can include a mood category indicator, a genre category indicator, an era category indicator, a person category indicator, and an activity category indicator. The category of the at least one attribute of a media category that is not displayed by any of the plurality of category indicators can be automatically determined.

In accordance with example embodiments of the present invention, one or more first-level and second-level attribute indicators can be displayed each displaying an attribute of a media category associated with one of the plurality of media category indicators. The media category that is not displayed by any of the plurality of category indicators can be included in a predetermined group of media categories to be displayed on the display. The plurality of category indicators can be arranged in a box configuration. One or more selectable first-level or second-level attribute indicators each displaying an attribute of a media category associated with one of the plurality of media category indicators, wherein selection of one of the one or more selectable first-level or second-level attribute indicators causes display of identifying information about one or more media files that possess the attribute represented by the selected one of the one or more first-level or second-level attribute indicators. The plurality of category indicators can include one or more category indicators each displaying a derived media category. The plurality of media category indicators can include one or more category indicators displaying an activity media category that is derived. One or more of the one or more attribute indicators display can be derived attributes.

In accordance with example embodiments of the present invention, a computer implemented method can include generating an active search query for defining parameters of a first play list. The active search query can be generated based on at least one user search request received through at least one input device. Using at least one processor, one or more media files can be identified that satisfy the parameters of the first play list. On at least one output device, a plurality of media categories can be displayed on a display, and the plurality of media categories can be associated with the first play list. The parameters of the play list can be defined by at least one attribute of a media category that is not displayed by any of the plurality of media categories.

In accordance with example embodiments of the present invention, one or more selectable attributes can be displayed on the at least one output device, each of which can be associated with one of the plurality of media categories. A selected attribute of the one or more selectable attributes can be received. The active search query can be automatically modified to include the selected attribute. The parameters of the play list can be automatically further defined based on the modified active search query. The play list and the display can be automatically updated in real time based on the further defined parameters of the play list. All of the one or more selectable attributes can be associated with media files in the play list. Information related to a selected media file from the first play list can be displayed on the at least one output device. The active search query can be displayed on the at least one output device. The plurality of media categories can include a mood category, a genre category, an era category, a person category, and an activity category.

In accordance with example embodiments of the present invention, one or more first-level or second-level attributes can be displayed on the at least one output device, each of which can be associated with one of the plurality of media categories. One or more second-level attributes can be displayed on the at least one output device, each of which can be associated with one of the plurality of media categories. The one or more second-level attributes can be hidden from presentation in the display unless an associated displayed first-level attribute category is selected. The plurality of categories can be displayed on the at least one output device in a box configuration. The at least one attribute of a media category that is not displayed by any of the plurality of media categories can be included in a predetermined group of media categories to be displayed on the display. The plurality of media categories can include one or more derived media categories. The plurality of media categories can include an activity media category that is derived. One or more of the one or more selectable attributes can be derived attributes.

In accordance with example embodiments of the present invention, a system can include a visualization controller, a search engine, and a play list module. The system can be a computer implemented system that includes at least one processor, at least one input device, at least one output device, and at least one non-transitory computer readable storage device. The system can include one or more displays generated by the visualization controller and output on the at least one output device for enabling exploration or recommendation of media files. The system can include one or more active search queries generated by the search engine based on one or more user search requests received through the at least one input device, and each of the one or more active search queries can correspond to one of the one or more displays. The system can include one or more play lists stored by the play list module, and each of the one or more play lists can have parameters that are defined by at least one attribute of a media category that is not displayed on the corresponding display.

In accordance with example embodiments of the present invention, the system can include a playback module, one or more media file databases, one or more index databases, and a client communications module. The system further can include a communications network. The media category that is not displayed by any of the plurality of media categories can be automatically determined. The media category that is not displayed on the corresponding display can be included in a predetermined group of media categories to be represented on the display.

In accordance with example embodiments of the present invention, the media category that is not displayed by any of the plurality of media categories can be automatically determined by a method caused by at least one processor executing instructions stored on at least one non-transitory computer readable storage device. The method that is caused by the at least one processor can include: (a) receiving a search string comprising a plurality of words; (b) parsing the search string to generate one or more combinations of the plurality of words; (c) searching for each of the one or more combinations against each of one or more synonym dictionaries; (d) determining a weight for each of the one or more combinations with respect to each of the one or more synonym dictionaries based on results of the executed search for each of the one or more synonym dictionaries; and (e) automatically selecting, to be the media category that is not displayed by any of the plurality of media categories, a media category associated with the combination of the one or more combinations that has the highest value of weight. The weight of each of the one or more combinations can be based at least in part on a matching percentage between the combination and one or more entries in the one or more synonym dictionaries. The search string can be parsed from left to right in such a way as to form the one or more combinations of the parsed search terms, and each of the one or more combinations can preserve original adjacency relationships in the received search string.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of an example system for implementing embodiments of the present invention;

FIG. 2 is a diagrammatic illustration of example index records for organizing media files, according to aspects of the present invention;

FIG. 3 is a diagrammatic illustration of a categorization scheme for organizing the various characteristics of a media file, according to aspects of the present invention;

FIG. 4 is a diagrammatic illustration of a hierarchical scheme for organizing one or more media files according to their characteristics, according to aspects of the present invention;

FIG. 5 is a diagrammatic illustration of example index records for several example songs, according to aspects of the present invention;

FIG. 6 is a flow chart depicting an example method for generating play lists and refining the play lists in real time, according to aspects of the present invention;

FIG. 7 is a diagrammatic illustration of an example display prior to receiving a preference or attribute from a user, according to aspects of the present invention;

FIG. 8 is a diagrammatic illustration of an example display subsequent to receiving a preferred attribute from a user and initiating playback of an automatically generated play list according to aspects of the present invention;

FIG. 9 is a diagrammatic illustration of a flow chart for modifying the example display to hide a category associated with an attribute submitted by a user according to aspects of the present invention;

FIG. 10 is a diagrammatic illustration of an example display prior to receiving a first attribute for generating an active search query according to aspects of the present invention;

FIG. 11 is a diagrammatic illustration of the example display of FIG. 10 subsequent to receiving a first attribute associated with a category represented by one of the category indicators according to aspects of the present invention;

FIG. 12 is a diagrammatic illustration of an example attribute pop-up window according to aspects of the present invention;

FIG. 13 is a diagrammatic illustration of an example song list pop-up window according to aspects of the present invention;

FIG. 14 is a diagrammatic illustration of an example display having a selected first-level attribute added to a search entry field according to aspects of the present invention;

FIG. 15 is a diagrammatic illustration of an example display having a selected second-level attribute added to a search entry field according to aspects of the present invention;

FIG. 16 is a diagrammatic illustration of additional display features enabling the saving of stations and the viewing of friends' stations according to aspects of the present invention;

FIG. 17 is a diagrammatic illustration of an example computing environment for implementing embodiments of the presenting invention;

FIG. 18 is a screen shot of an example display prior to receiving a preference or attribute from a user according to aspects of the present invention;

FIG. 19 is a screen shot of an example display having an example attribute pop-up window corresponding to the category “Person” according to aspects of the present invention;

FIG. 20 is a screen shot of the example display of FIG. 19, subsequent to the action by a user of selecting the attribute indicator for “Sonu Nigam,” and depicting the attribute “Sonu Nigam” added to a search bar, according to example implementation aspects of the present invention;

FIG. 21 is a screen shot of an example display presenting a non-textual attribute subsequent to generating a play list and initiating playback the play list according to aspects of the present invention;

FIG. 22 is a screen shot of the example display of FIG. 21 subsequent to an action by a user of initiating attribute pop up windows for an attribute displayed in a category indicator and an attribute displayed in an outer ring portion, according to aspects of the present invention;

FIG. 23 is a screen shot of the example display of FIG. 22, subsequent to an action by a user of selecting the “Sad” attribute indicator from the attribute pop-up window, according to aspects of the present invention;

FIG. 24 is a screen shot of an example display having a trivia pop-up window according to aspects of the present invention;

FIG. 25 is a screen shot of an example display that includes a stations pop-up window as a result of an action by a user of selecting a “My Stations” button according to aspects of the present invention;

FIG. 26 is a screen shot of an example display that includes a stations pop-up window as a result of an action by a user of selecting a “My Friends' Stations” button according to aspects of the present invention;

FIG. 27 is a screen shot of the example display of FIG. 26, further depicting sub-lists of friends' stations on the stations pop-up window as a result of an action by a user of selecting one or more of the displayed lists according to aspects of the present invention; and

FIG. 28 is a screen shot of an example display having a Friends Filter that enables a user to send one or more friends an invite to use and share media through embodiments of the present invention.

### DETAILED DESCRIPTION

An illustrative embodiment of the present invention relates to a computer implemented display for organizing, visualizing, and recommending music and other types of performances. The display generates a dynamic play list based on user-entered criteria and preference(s) and plays media files from the play list. The display visually segregates attributes of a performance being played, based on categorical differences between the attributes. This enables the user to identify which characteristics contribute to an enjoyable or less desirable experience. The display also presents users with additional possible characteristics that can be used to further narrow the play list (e.g., by adding text strings to the active search query or by modifying the existing search string). Thus, users are allowed to select additional desired criteria for discovering new performances that fit their current personal preferences. Giving a user real-time control over his or her listening/viewing experience enables enhanced customization and more targeted usage of the display.

The term “media file” is used herein to refer to any performance having a tangible format that enables the file to be stored on a computer-readable medium or transmitted across a communication network. This can include audio files (e.g., songs, lectures, books on tape, stand-up comedy performances, and any other performance recordable in an audio file format), video files (music videos, movies, television shows, live streaming videos, and any other performance recordable in a video file format), picture files (e.g., art work, paintings, photographs, digital images, and any other recordable digital file format), and any other type of performance having analog, digital, or other recordable format. The term “media file” includes pre-recorded performances, performances being recorded in real time, performances that are streaming (live or pre-recorded), performances that are broadcast by radio stations, and other types of performances involving conversion to a tangible format capable of being stored on a computer-readable medium or transmitted across a communication network.

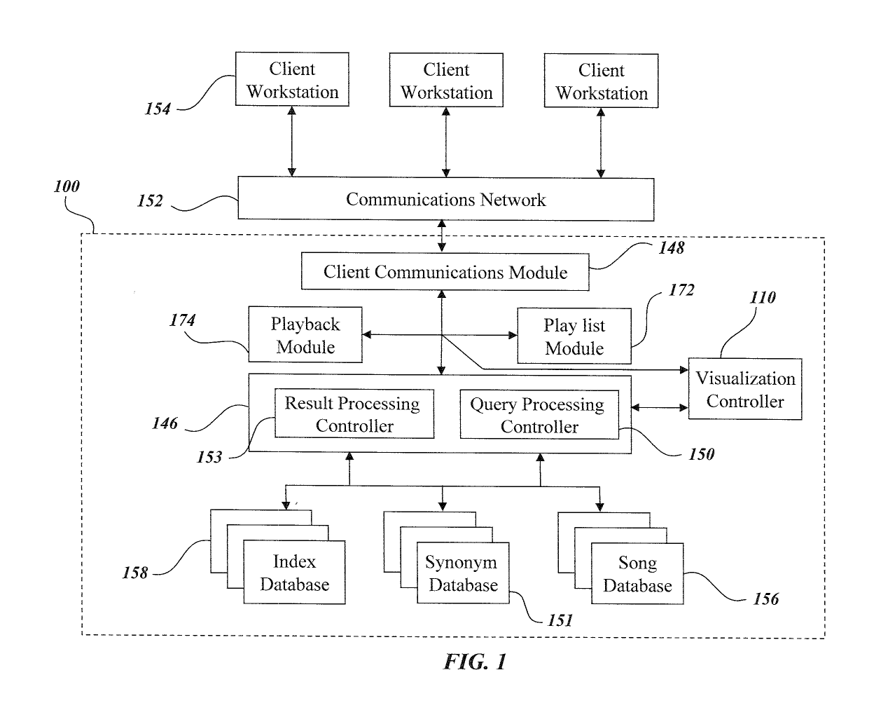

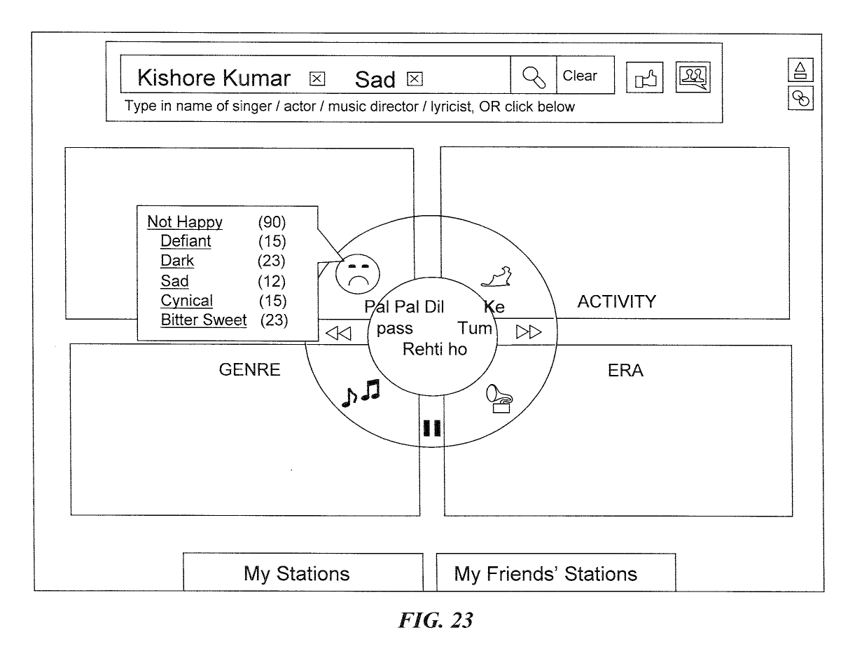

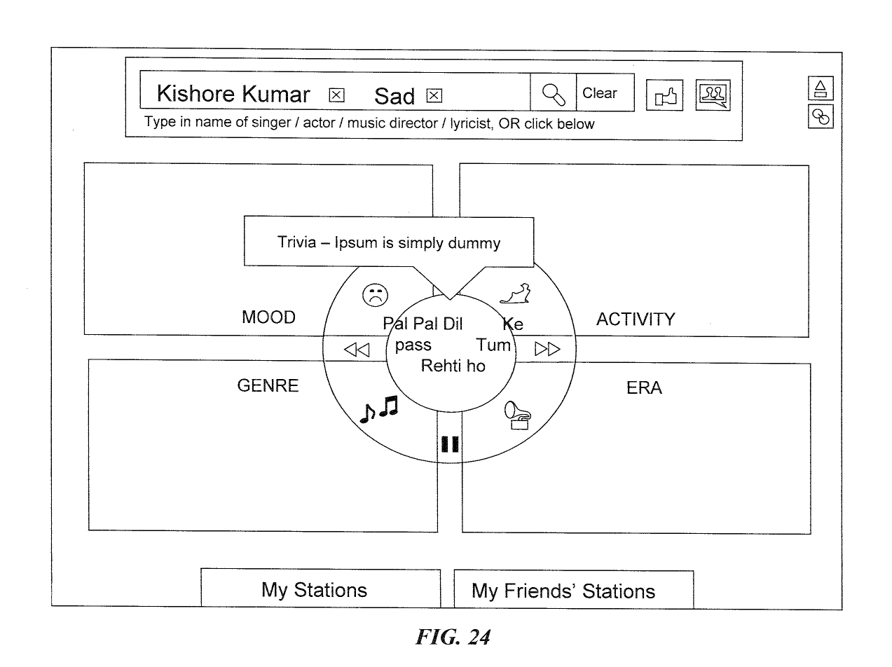

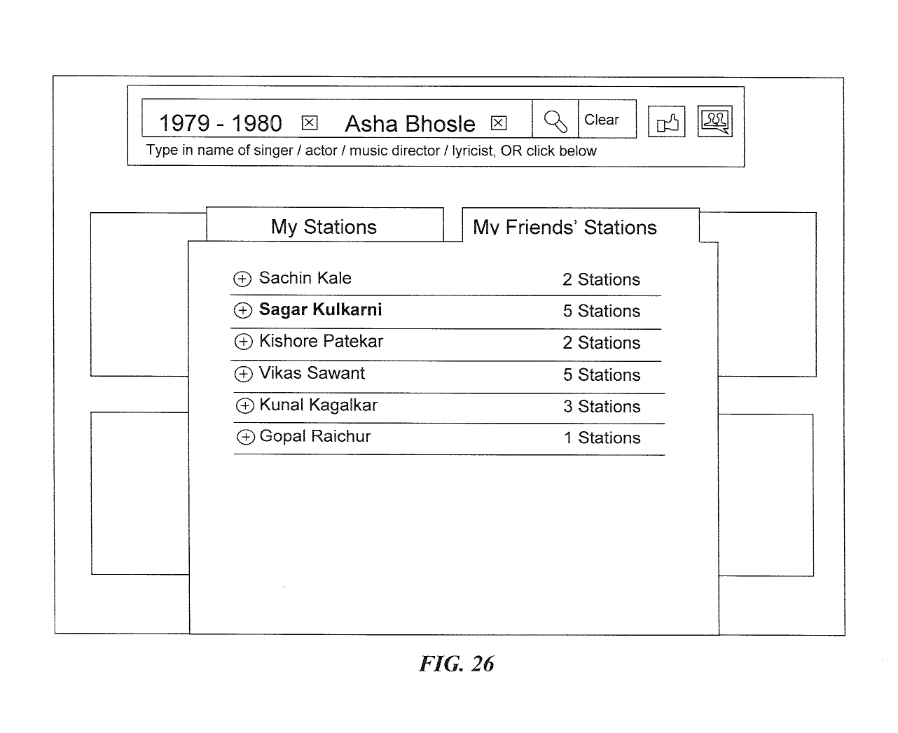

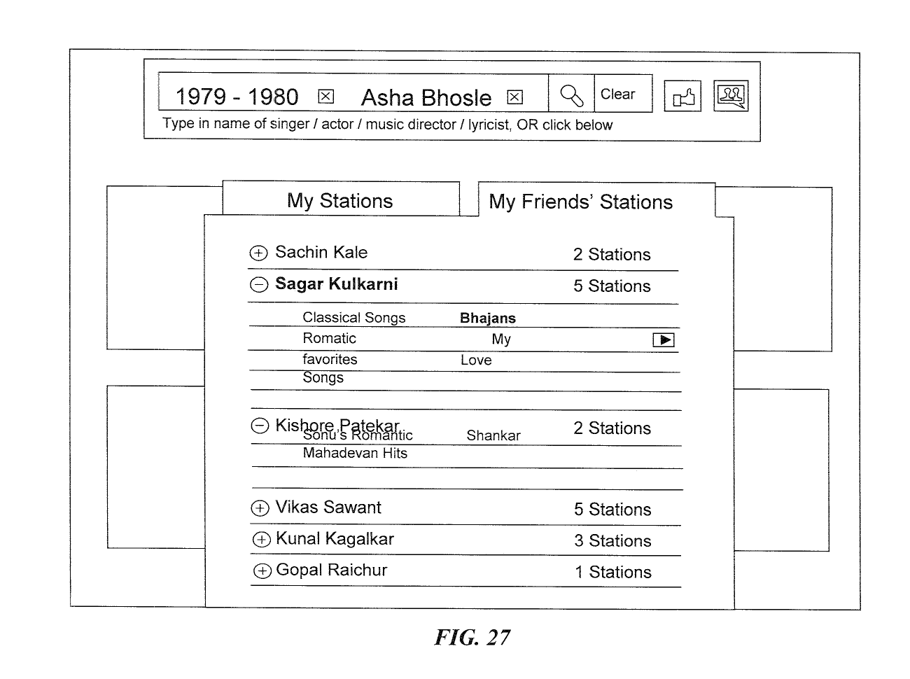

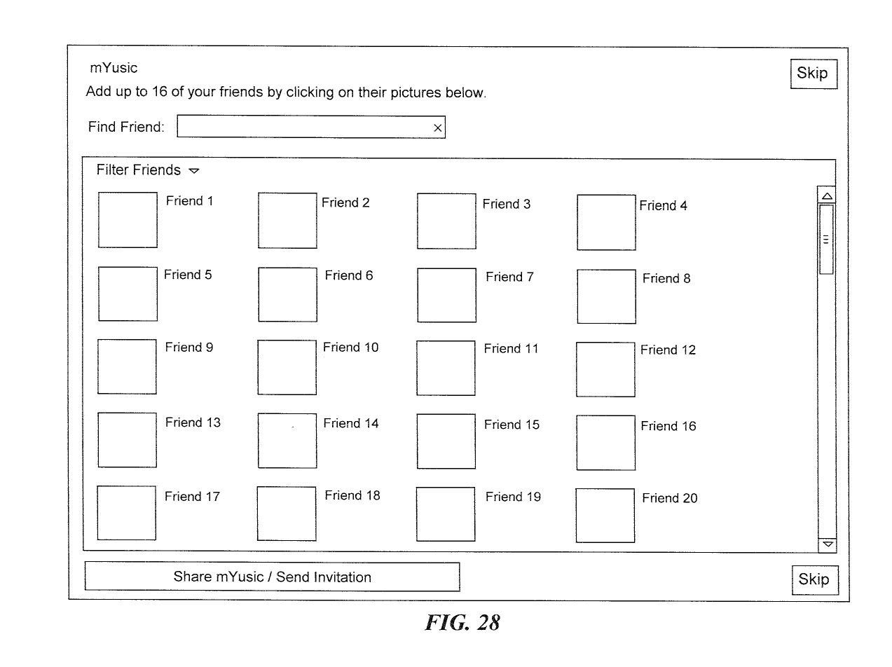

FIGS. 1 through 28, wherein like parts are designated by like reference numerals throughout, illustrate example embodiments of a computer implemented display that plays, presents, and categorizes pre-recorded, musical, audio media files, herein referred to as “songs.” Although the present invention will be described with reference to the example embodiments illustrated in the figures and pertaining to songs, it should be understood that many alternative forms (e.g., of media files) can embody the present invention. In no way are embodiments of the present invention limited to prerecorded audio musical content. Rather, this example performance type is described for illustrative purposes only; embodiments of the present invention can be implemented with any media file or combination of media files, as defined herein. One of skill in the art will appreciate many different ways to alter the parameters of the embodiments disclosed, such as the performance content, type of media file, particular layout, display features, and specific categories and attributes, in a manner still in keeping with the spirit and scope of the present invention.

FIG. 1 is a block diagram of an example system 100 for implementing embodiments of the present invention. The system 100 communicates with one or more client workstations 154 via a connection to a communications network 152 (e.g., the Internet). The system 100 includes a search engine 146, a client communications module 148, a playback module 174, and a play list module 172. The search engine 146 can include a query processing controller 150 and a result processing controller 153. The system 100 further can include a visualization controller 110. The client communications module 148, playback module 174, search engine 146 (including the result processing controller 146 and the query processing controller 150), the play list module 172, and the visualization controller 110 can all be connected (e.g., logically) to each other and in communication with each other. The search engine 146 can generate queries to search one or more song databases 156, or data stores. The search engine 146 can also access and search one or more index databases 158 and a synonym database 151. The synonym database 151 includes one or more dictionaries. The one or more dictionaries specifically can include a dictionary of natural language synonyms, a dictionary of categorization synonyms, and other dictionaries. The one or more index databases 158 can contain index records of the files stored in the one or more song databases 156.

The client workstations 154 can be any number of computing devices, including, by way of example, “laptop,” a “desktop,” a “hand-held device,” a “mobile device,” a “tablet computer,” a “portable transceiver,” a “set-top box” (e.g., for internet TV), and any other computing device. As such, some or all of the features, components, and functions of the system 100 can be customized in order to accommodate the type of workstation 154 with which the system 100 is communicating.

For purposes of illustration, the example system 100 is simplified and depicts the various modules and components as discrete blocks. However, one with skill in the art will appreciate that the modules and other components of FIG. 1 can be grouped together or split apart in a variety of ways, depending on the intended applications and the particular computing environment. Furthermore, in some embodiments, a module or component represented by only one block actually is implemented with multiple such modules or components. Additionally, components depicted as being contained within the system 100 can be excluded from the system 100, and components depicted as being excluded from the system 100 can be incorporated into the system 100. For example, the communications network 152 can be included in the system 100, and the song database 156 can be excluded from the system 100. For instance, in some alternative embodiments, the system 100 connects to one or more remote databases (e.g., hosted in “the cloud,” by a remote server, etc.) via a network, thereby allowing the system 100 to access songs stored in remote databases. One of skill in the art will readily appreciate a variety of additional ways to expand, reduce, or alter the example system 100. All such alterations are contemplated within the scope of the present invention.

Accordingly, in addition to or as alternatives to the song database 156 depicted in FIG. 1, the system 100 can be configured to access other song databases that are remote from the system 100. In embodiments involving such remote databases, songs need not be stored directly in the song database 156. Rather, the system 100 can include modules that enable access and playback of songs in remote databases, as would be appreciated by one of skill in the art upon reading the present specification. Furthermore, in such embodiments, additional index records can be created (e.g., automatically) in the index database 158 that point to songs in remote databases. In yet further embodiments, the indices of such index records can be populated automatically based on the information from a remote database regarding song characteristics.

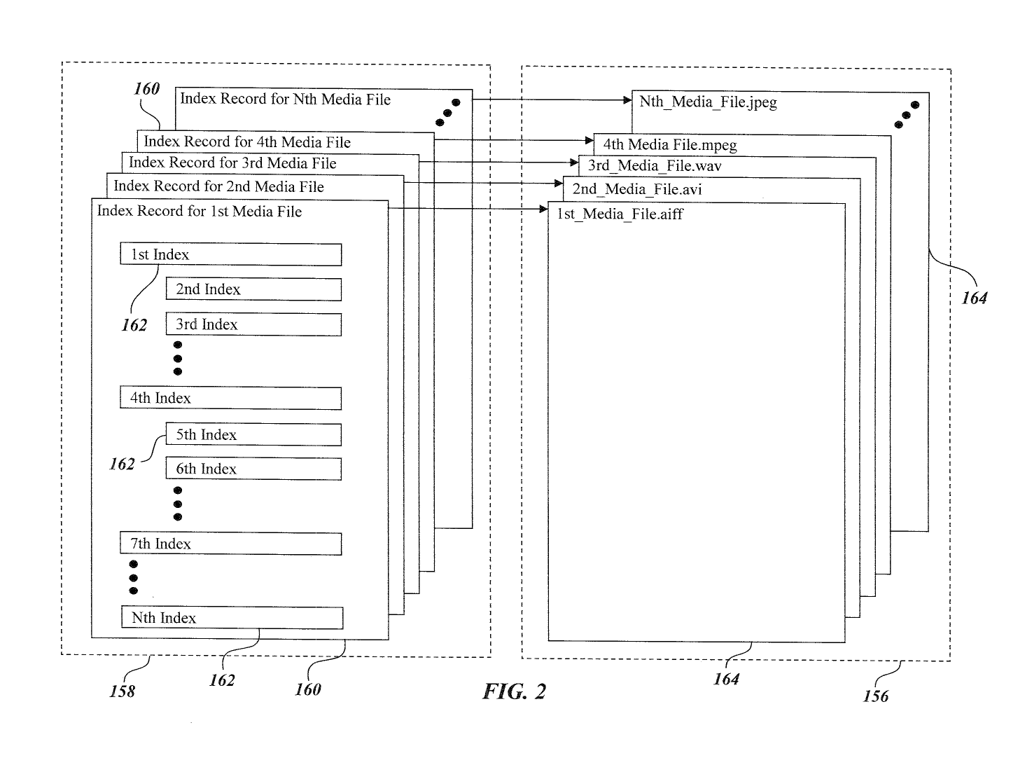

FIG. 2 is a diagrammatic illustration of one example implementation of the song database 156 and the index database 158. Within the index database are one or more index records 160. Each index record can be associated with a song 164 stored in the song database 156. The song database 156 stores the songs 164 themselves, which can be in any file format, and which can be readable by the playback module 174. Each index record can have one or more indices 162. Each index 162 can be a particular quality or characteristic (musical or non-musical) of the song 164 with which the index record 160 is associated. One or more indices 162 can be grouped within an index record 160.

The index records can be organized and grouped within the index database 158 according some or all of the indices 162. Preferably, the system 100 indexes each index record 160 according to all of its associated indices 162. One of skill in the art will readily appreciate how to implement such an index structure upon reading the present specification. Additional description of this structure and process of indexing therefore is not provided herein. Segregating index records 160 according to the indices 162 can enable greater speed when searching by indices 162. This promotes faster recall of the desired index records 160, faster generation of a play list, and faster initiation of playback of the play list.

As discussed in further detail herein, the indices 162 can be the qualities or characteristics (musical and non-musical) of a given song. The particular musical and non-musical characteristics can be based on two illustrative organizational concepts, “categories” and “attributes.” Specifically, an “attribute” is herein defined to be a particular quality or characteristic of a song, e.g., “happy,” “medium tempo,” “featured in a movie,” “featured in the movie Snow White,” and other qualities or characteristics. A “category,” as used herein, is a taxonomic classification for distinguishing different types of attributes. For example, categories can include “Mood,” “Person or Entity,” “Era,” “Genre,” and “Activity.” “Mood” can include attributes such as “happy,” “sad,” and other moods. “Person or Entity” can include attributes related to people or entities related to the song. This can include composers, lyricists, producers, actors appearing in movie scenes or music video scenes where the song is played, etc. “Era” can include attributes related to the specific year or time period during which a song was created, such as “the 1970s,” “the 1980s,” etc. “Genre” can include attributes related to the musical genre or the musical label to which the song belongs, such as “Pop,” “Hip-hop,” “Jazz,” “Spanish-influenced,” and the like. “Activity” can include activities suitable for performing while listening to a song or activities during which listening to the song is particularly desirable. Example activities include “Mowing the lawn,” “Exercising,” “Having a romantic dinner,” and the like.

These definitions allow categories and attributes to be somewhat interchangeable. For example, one attribute of a song is whether the song “has a composer.” On the other hand, “Composer” can be a category for classifying songs based on who the particular composer is.

Furthermore, attributes can be further defined or further qualified by additional, more specific, attributes. Therefore, attributes can be assigned particular hierarchical levels, such that there can be “first-level” attributes and “second-level” attributes. Both first-level attributes and second-level attributes are distinct qualities of a song that fall within a particular category. However, a second-level attribute is narrower than a first-level attribute, and further defines a first-level attribute by specifying additional properties or features of the first-level attribute. For example, the first-level attribute “Unhappy” can be further qualified according to the second-level attribute “Sad.” “Sad” is a type of unhappiness. As another example, “Composed by John Lennon” can be a second-level attribute for the first-level attribute, “Composer” (e.g., indicating that the song has a composer), which in turn can be a first-level attribute in the category “Person or Entity.” Attributes can have n levels of hierarchy, with increasing values of n corresponding to higher (i.e., narrower) levels of attributes.

Similar to levels of attributes, categories too can have hierarchical levels. For example, the category “Person” alternatively can be organized into sub-categories, such as “Composer,” “Lyricist,” “Actor,” and the like. The sub-category “Composer” (or “Music Director”) contains attributes such as “John Lennon” and “Elvis,” while the sub-category “Lyricist” contains attributes such as “Eric Clapton” and “Ira Gershwin.” Therefore, characteristics can be represented in a variety of ways. Like attributes, categories too can have n levels of hierarchies (e.g., sub-categories), with increasing values of n corresponding to higher (i.e., narrower) levels of categories.

In embodiments pertaining to songs (e.g., music files), categories can be related to musical qualities of the songs or unrelated to musical qualities of the songs. Examples of categories that are related to the musical qualities include tempo, genre or musical influence, musical arrangement characteristics, vocal characteristics and vocal nuances, rhythm cycles and characteristics, and instrumentation. Examples of categories that are unrelated to the musical qualities include mood, era, activity appropriateness, plot situation (e.g., the plot situation of a scene from a movie or music video, in which a song is featured), picturization location (e.g., the location of a scene from a movie or music video in which a song has been featured), and degree of popularity.

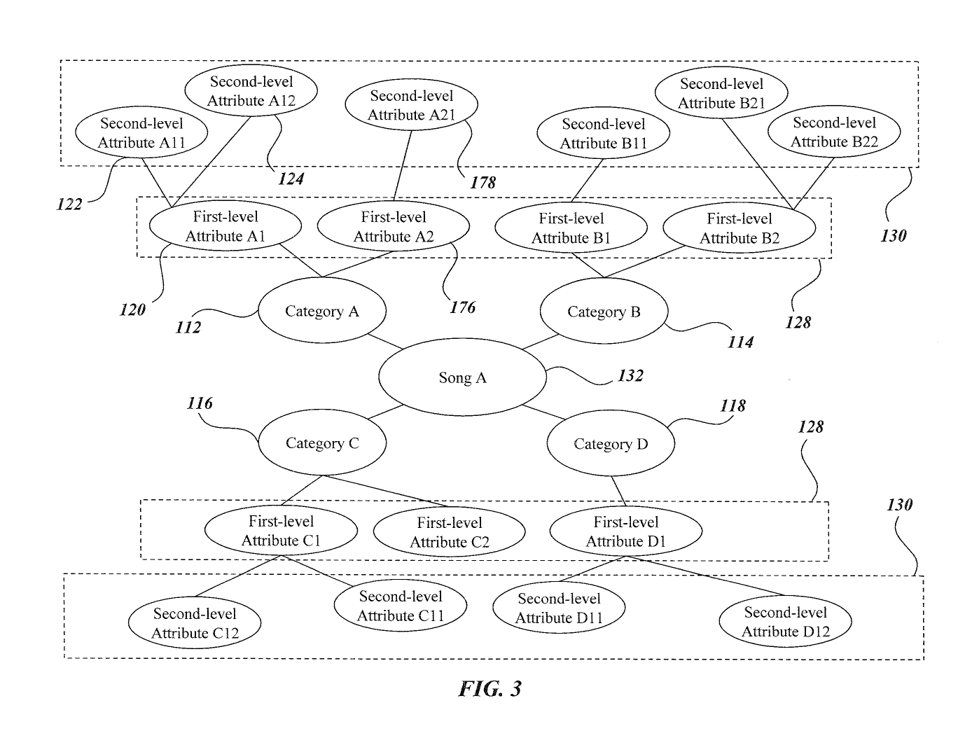

FIG. 3 depicts an example song 132 having attributes falling within four categories 112, 114, 116, and 118 of classification. Connected to categories 112, 114, 116, and 118 are first-level attributes. Each bubble contained within dashed boxes 128 is a first-level attribute that represents a characteristic belonging to the particular category 112, 114, 116, or 118 in which that characteristic is connected. Connected to the first-level attributes are second-level attributes. All bubbles contained within dashed boxes 130 thus represent second-level attributes that further define or qualify the particular first-level attribute to which each is connected While FIG. 3 depicts only four categories, the illustrative display preferably utilizes five or more such categories of classification. However, any number of categories, first-level attributes, and second-level attributes are possible.

For purposes of illustration, the example song 132 can be the popular Beatles song, “I Want to Hold Your Hand,” as originally recorded and released. Example category 112 can be “Person or Entity.” An example first-level attribute 120 can be “Composer,” and an additional example first-level attribute 176 can be “Artist or Band.” Example second-level attribute 178 can be “The Beatles.” Example second-level attribute 122 can be “Paul McCartney,” and additional example second-level attribute 124 can be “John Lennon.” Both “Paul McCartney” and “John Lennon” are listed as second-level attributes 122 and 124 for the example first-level attribute “Composer” 120 for example song “I Want to Hold Your Hand” 132 since both McCartney and Lennon are listed as composers of the song. It is worth noting that “Artist or Band,” while depicted as a first-level attribute, can alternatively be considered a sub-category, as described herein.

The number of attributes and the specific attributes themselves will vary from song to song. While FIG. 3 illustrates numerous first and second-level attributes for each example category 112, 114, 116, and 118, other implementations are possible and likely. A particular song need not possess any second-level attributes, or even any first-level attributes, for a given category. In addition, higher-level attributes, such as third-level attributes, fourth-level attributes, etc. can be used. There is no upper limit on the number of additional branches to the classification scheme depicted in FIG. 3.

It is worth noting that the categories themselves can be specific to a particular culture, genre, media type, etc. For example, it is more common in India for songs to become popularized by their appearance in movies than it is in the United States. Therefore, while “Movie” (e.g., which indicates a movie in which the song appeared) can serve as a category (or, alternatively, as an attribute), it may not be particularly useful for a U.S. audience that is more accustomed to songs being popularized, e.g., by radio. For embodiments targeted to both U.S. and Indian users, it is permissible for only some of the songs in the database 156 to have attributes falling within the “Movie” category.

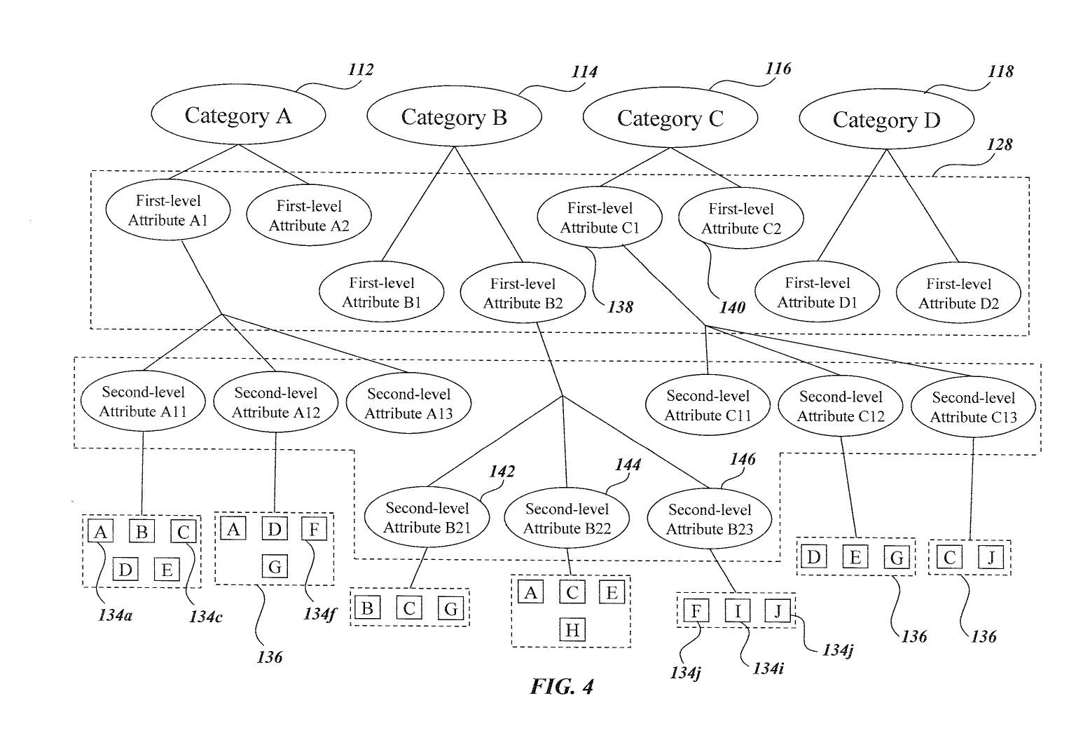

Returning to an illustrative embodiment, FIG. 4 is a diagrammatic illustration of how the categorization scheme of FIG. 3 can be implemented to provide groupings of multiple songs. In FIG. 4, songs are illustrated by squares 134a through 134j. Dashed boxes 136 represent collections of songs satisfying the various criteria imposed by the attributes to which each dashed box 136 is upwardly connected. Any bubble contained within dashed box 128 represents a first-level attribute, and any bubble contained within dashed box 130 represents a second-level attribute. Distinct categories 112, 114, 116, and 118 are depicted at the top of FIG. 4.

The organizational scheme of FIG. 4 can be used to group collections of songs having similar qualities. As an example, consider example category “Mood” 114 of FIG. 4. An example first-level attribute 138 can be “Devotional” and an additional example first-level attribute 140 can be “Sentimental.” Example second-level attribute 142 can be “Patriotic,” additional example second-level attribute 144 can be “Philosophical,” and additional example second-level attribute 146 can be “Nostalgic.” Example song 134f can be “Misty” by Errol Garner, additional example song 134i can be “I Will Remember You” by the Sarah McLaughlin, and additional example song 134j can be “Yesterday” by the Beatles.

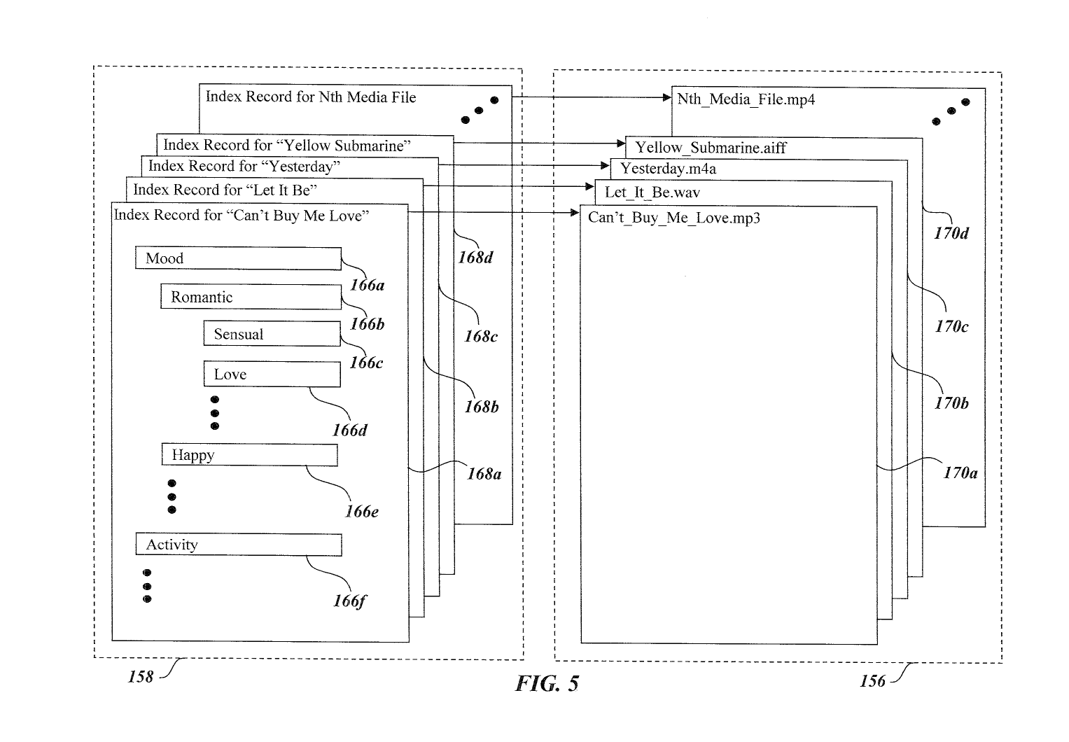

FIG. 5 is a diagrammatic illustration of an example implementation of the classification schemes of FIGS. 3 and 4, as implemented in the song database 156 and the index database 158. For purposes of illustration, example songs 170a through 170d are songs recorded by the popular band, the Beatles. The index records 168a through 168d correspond to the example song files 170a through 170d, as indicated by arrows. Therefore, index record 168a corresponds to the song file 170a for the song, “Can't Buy Me Love.”

As depicted in FIG. 5, example index record 168a for “Can't Buy Me Love” includes several example indices 166a through 166f. These indices include two example categories, “Mood” 166a and “Activity” 166f. Example category “Mood” 166a includes two example first-level attributes, “Romantic” 166b and “Happy” 166e. Example first-level attribute “Romantic” 166b includes two example second-level attributes, “Sensual” 166c, and “Love” 166d. Each example index record 168a through 168d in example index database 158 is associated with the corresponding song 170a through 170d in the example song database 156.

Due to the organization of the index records 160 according to category-based and attribute-based indices 162, songs 164 stored in the database 156 can be searched and filtered into play lists characterized by specific attributes. The specific attributes can be selected by a user that is operating a client workstation 154, such that the play list provides recommendations of songs that satisfy the user's preferences.

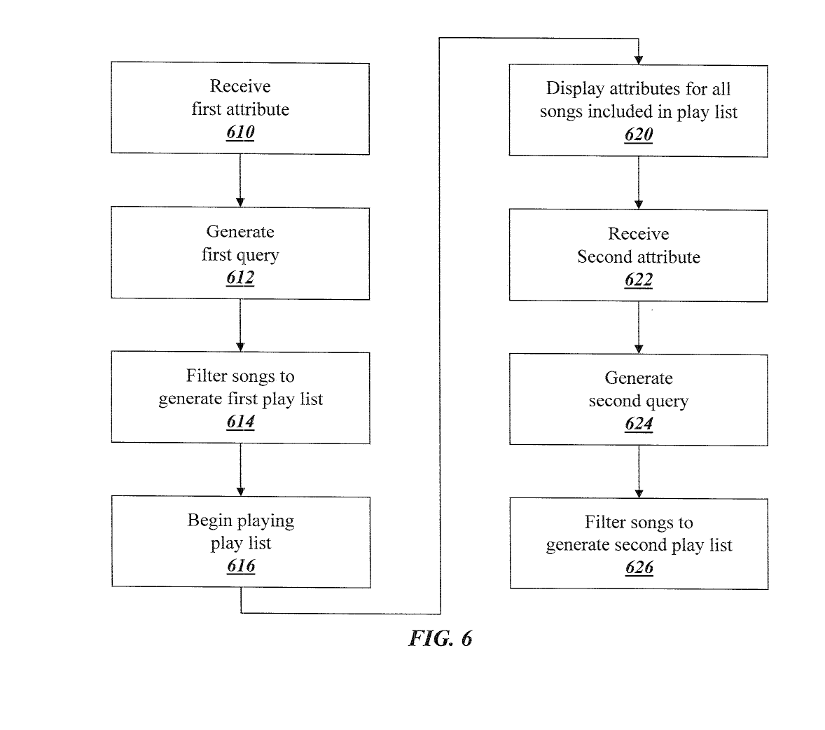

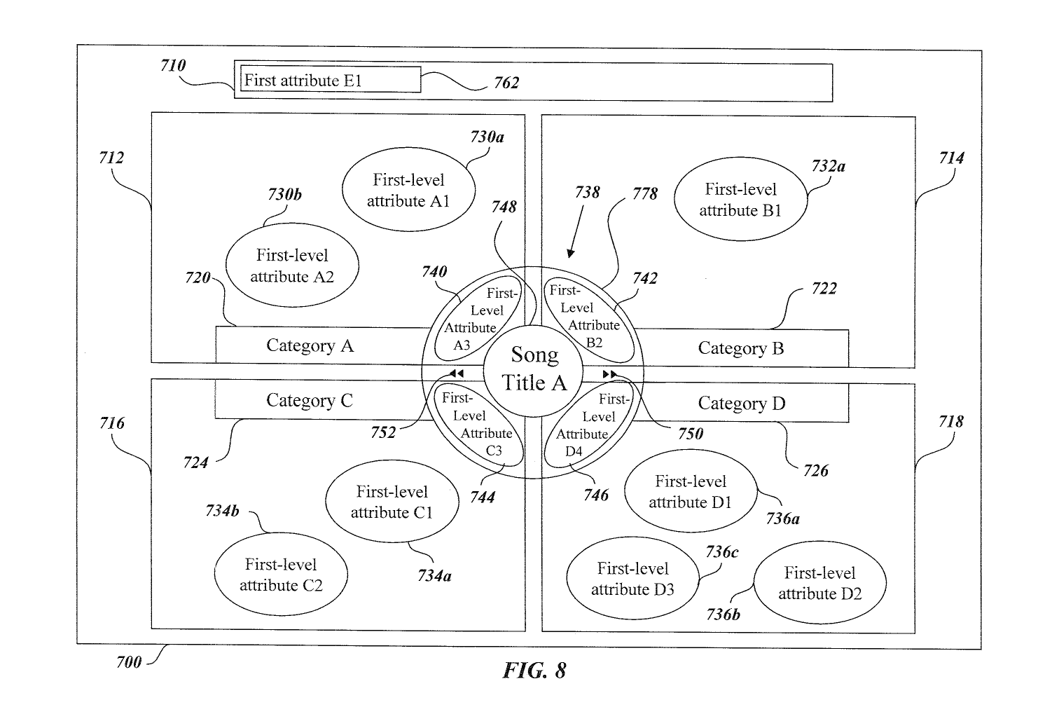

FIG. 6 depicts an example method for generating recommendations of songs based on a user's preference. Additionally, the method of FIG. 6 enables the recommendations to be updated in real time in response to further input of preferences from the user. First, a client workstation 154 (e.g., operated by a user) selects and submits a first attribute for generating a play list of performances having a particular desired characteristic associated with or represented by the selected attribute. (The first attribute is depicted later in FIG. 8 as first attribute 762, and generally can be a first-level attribute, a second-level attribute, a higher-level attribute, or based on text manually entered by a user. Furthermore, the first attribute 762 can be entered manually need not be displayed on the screen or even associated with any of categories that are displayed on the screen. Rather, the first attribute 762 can be an attribute that is associated with a category that is not currently being displayed.) The first attribute 762 is sent from the client workstation 154 to the client communications module 148 of the search engine 146 via the communications network 152 (step 610). The query processing controller 150 uses the first attribute 762 to generate a first active search query (step 612). What is meant by an “active” search query is that the search query is automatically generated and executed upon receiving the first attribute 762 or any other search term entered into a search entry field, and that the search query can be automatically updated and re-executed in real time upon receiving subsequent search terms. Generating the first active search query can optionally include a number of well-known functions, including parsing, stemming, translating, improving recall, adjusting relevancy, applying synonyms, adjusting query to reduce noise, and other known operations related to creating queries. Once the active search query is generated, it can be used to search and filter the database 156 to generate a play list (step 614) of songs (e.g., of song titles, song locations, song identifiers, and/or other identifying information of songs satisfying the parameters defined by the active search query). Said differently, the active search query defines parameters for a play list of songs satisfying the active search query. Thus, the play list includes one or more songs satisfying the parameters of the play list, which are defined by the active search query. As an example, the step 612 of generating a first active search query can include the query processing controller 150 accessing the index database 158, searching for indexes 162 that match the first attribute 762, and returning all of the index records 160 associated with the matching index 162. In some embodiments, the search queries include a plurality of different query parameters, e.g., defined according to the various categories to be searched. The play list module 172 can store a list (a “play list”) of the songs associated with the index records 160 retrieved as a result of the active search query, along with the category and attribute information from the indices 162 associated with each song on the play list. Thus, the songs listed on the play list satisfy the parameters of the play list, as defined by the active search query. In alternative embodiments, the play list module 172 can store the one or more media files corresponding to retrieved songs, rather than simply storing the list of titles, locations, and/or other identifying information related to the one or more songs.

By searching and filtering in this manner, the search engine 146 can produce a list of songs satisfying the criteria imposed by the first attribute 762. This is because the first attribute 762 defines an active search query that, in turn, defines parameters for the play list. Songs on the play list satisfy the parameters, and thus possess the first attribute 762 submitted from the client workstation 154. Therefore, all songs on the play list will possess the characteristic initially desired by the user that is operating client workstation 154.

The songs on the play list, which are accessible via the song database 156, can be queued up for playback, as desired. Additionally, songs that are listed on the play list can begin to be played at the client workstation, one at a time (step 616). In an illustrative embodiment, this involves the playback module 174 accessing a play list module 172 and randomly selecting a song from the play list. Upon selecting a song, the playback module 174 commands the query processing controller 150 to access the selected song from the song database 156 and initiates playback of the selected song. Playback of the song on the client workstation 154 is accomplished via the client communications module 148, which preferably streams the audio content of the selected song across the communications network 152 to the client workstation 154. More specifically, “selected,” within the context of a “selected song” of the illustrative embodiment, herein refers to a song that has been chosen for playback. Accordingly, a song need not be playing in order to be selected for playback, since in some embodiments a user may pause the song while it is playing.

The play list module 172 can track which songs have been played (e.g., using one or more databases, caches, histories, other tracking and/or storage mechanisms, and combinations thereof) to the particular client workstation 154, in order to enable a variety of additional features. Such features can include preventing repeated playback of a song until the client workstation 154 has undergone a predetermined number of sessions, creating a history for tracking songs that have played to the client workstation 154, enabling implicit relevance matching based on user selection histories, and other known functions related to historical user data or the statistical manipulation thereof.

Selection of songs from the generated play list need not be random. Rather, alternative embodiments of the present invention assign particular attributes to songs along with an attribute value. The attribute value can indicate the degree to which a particular song possesses a corresponding attribute. In such alternative embodiments, the query processing controller 150 can generate matching percentages of the search results. Selecting songs for playback therefore can be based on the particular matching percentages. For example, upon generating a play list, the playback module 174 can begin playing songs that possess the highest percentage of the desired characteristic, as determined by the initial user selection of the first attribute 762. The matching logic may itself also reference user feedback obtained via a “Like” feature in order to improve song relevance ranking and/or ordering on a per-user basis.

Upon creation of the play list, the system 100 can display to the client workstation 154 all or some of the attributes associated with the songs on the play list (step 620). These additional attributes displayed to the client workstation 154 can be all of the attributes falling within one or more predetermined categories. In an illustrative embodiment, the one or more predetermined categories comprise four categories selected by the system 100. The system 100 thus displays all of the play list's songs' attributes associated with the four selected categories.

Notably, the system 100 can be configured to determine the category with which the first attribute 762 is associated. Specifically, this can be implemented by utilizing one or more synonym dictionaries, which provide lists of alternate valid entries for each of the plurality of searchable attributes. As an example, synonyms for the attribute “Happy” can include alternate valid entries such as “Joyful,” “Glad,” and “Cheerful.” Utilizing synonym dictionaries enables multiple different words or phrases to map to the same attribute, such that a search for any one of a group of synonyms results in the same active search query being generated. In general, the synonym dictionaries can include synonyms, alternate spellings, abbreviations, values of a range, nicknames, slang, translations, and other types of synonyms.

The system 100 can search the synonym dictionaries (person synonym dictionary, attribute synonym dictionary, and basic synonym dictionary) in the following manner, in accordance with one example embodiment of the present invention. Upon receiving a search string (e.g., which forms a query) from the search bar, the query is parsed from left to right to generate every n-word combination, i.e., to generate every n-word combination that can be formed without rearranging the word order of the parsed words. Furthermore, in illustrative embodiments, each of the combinations preserves original adjacency relationships in the search string. Said differently, only those words that are adjacent in the original search string are allowed to be adjacent in the resulting combinations. For example, if n=3, then the search “Happy John Lennon 1960s” results in the search engine 146 generating the following nine combinations of length n or less: “Happy,” “John,” “Lennon,” “1960s,” “Happy John,” “John Lennon,” “Lennon 1960s,” “Happy John Lennon,” “John Lennon 1960s.” The combination “Happy Lennon” is not created since this does not preserve the original adjacency relationships in the search string (i.e., “Happy” and “Lennon” are not adjacent in the original search string).

The formula for determining the number of different combinations according to this method is (n*number of terms in query)−(Sum(1, . . . , n−1)). In this example where n=3, number of terms in query=4, and n−1=2. Therefore, the formula evaluates to (3*4)−(1+2)=12−3=9. There is one exception, however: if the number of terms in a query is less than the assigned value of n; then n is automatically adjusted to equal the number of terms in query. For example, if the query is “John 1960s”, then there are 3 combinations (John, 1960s, John 1960s) that satisfy the formula when n=3. In this example, since number of terms is 2 and the value of n is 3, n is automatically adjusted to the value of 2. Applying the formula delivers: (2*2)−(1)=3. The value of n for a dictionary is equal to the maximum number of words for any phrase in the given dictionary. Parsing the query from left to right is important to determine the index value (IV) of the combination. Index value (IV) is the position of a combination in the ordered combination set. So, from above example, the 9 generated combinations (Happy, John, Lennon, 1960s, Happy John, John Lennon, Lennon 1960s, Happy John Lennon, John Lennon 1960s) will have index value (IV) 1 to 9, respectively, in the same order as they are generated. The search engine 146 then executes this algorithm against each of the synonym dictionaries and against the noise reduction module. Each of the combinations is given a score based on index value (IV) of the combination, weight (W) of the combination for each of the dictionaries, and number of characters in the combination. Regarding weight (W), if there is an exact match for a combination in the dictionary, then the weight for that combination will be 1 (whole match). Consider a scenario in which there is more than one combination matching within the same dictionary and in which words of the combinations overlap. For example, assume the person dictionary includes a first person entry “Happy John” and a second person entry “John Lennon.” Because of the overlap in the word “John,” the weight (W) assigned by the process described herein will be shared among the combinations. Thus, in the above example, “Happy John” and “John Lennon” will each receive a weight (W) of 0.5. Finally, the particular combination with the highest score is selected by the system 100 as the first attribute 762, and the corresponding category associated with the first attribute is identified.

In an illustrative embodiment, the system 100 includes four separate synonym dictionaries, a topic dictionary, a language dictionary, a person dictionary, and a range dictionary. The topic dictionary can include all entries related to mood, genre, activity, and other topics. For example, synonyms in the topic dictionary can include synonyms for the category or synonyms for the attributes in a category (e.g. “Happy” and “Joyful” refers to “Happy” category). The language dictionary includes abbreviations (e.g., “comedic” and “LOL”), alternate spellings (e.g., “Colorful” and “Colourful”), slang (e.g., “Just Relaxing” and “chilling”), translations (e.g., “Tired” and “Cansado”), and other types of synonyms. The person dictionary can include all entries related to people and entities, including composers, singers, film directors, actors, music directors, lyricists, and other people or entities. For example, synonyms in the person dictionary can include nicknames (e.g., “Charlie Parker” and “Bird”), initials (e.g., “John Lennon” and “JL”), first names (e.g., “John”), last names (e.g., “Lennon”), alternate spellings (e.g., “the Beatles” and “the Beetles”), abbreviations (e.g., “the Beatles” and “Beatles”) and other synonyms. The range dictionary includes all entries related to number ranges and values, including eras/years, tempo, and other topics. For example, synonyms in the range dictionary can include abbreviations ('90s), full expressions (1990s), particular values of a range (1995, 1994-1997), and other synonyms. The system also excludes noise in search results by using the topic dictionary and the person dictionary. For example, if the user searches for “Happy John Lennon 1960s”, the results will have songs related to “John Lennon” and not “Kipp Lennon” or “John Mellencamp.”

In the illustrative embodiment, the system 100 determines the category associated with the first attribute 762 and intentionally excludes this category from the four selected categories that are displayed. (Nonetheless, the first attribute 762 is preferably displayed on a search entry field, such as a search bar 710 of FIG. 8.) An illustrative embodiment, upon receiving a first attribute 762, outputs additional attributes to the user. Furthermore, in such embodiments, the additional attributes or indices can themselves be searched. Thus, in a way, the results of the generated active search query include possible additional query terms for expanding upon and/or modifying the generated active search query. The possible additional query terms (e.g., attributes) can be displayed to the user, and the user can choose to execute any of the additional possible queries simply by issuing the proper command (e.g., clicking or typing). Thus, the possible additional query terms can provide ways to adjust the recommendations based on additional preferences of the user, as will be described in greater detail herein.

Continuing with the example method of FIG. 6, once a user selects a second attribute from the additional attributes that are displayed to the client workstation 154, the second attribute is transmitted across the communications network 152 and received by the client communications module 148 (step 622). The additional preferences of the user are received and processed by the system 100 as new queries. Thus, the search engine 146 generates a second active search query (e.g., a modified version of the original active search query) that includes both the second selected attribute and the first attribute 762 as search strings (step 624). Then, in the same manner described previously, a second play list is generated (step 626). Specifically, the search engine 146 uses the second active search query to search the index database 158. The second play list containing songs that meet the criteria of the second active search query is stored by the play list module 172 (e.g., in a cache, database, as metadata, or using any other suitable storage mechanism as would be appreciated by one of skill in the art). Next, the playback module 174 initiates playback of the second play list at the client workstation 154.

In addition to the active search query and play list features depicted in FIG. 6, an illustrative embodiment of the present invention includes an improved information display for presenting information to the user. Such information can include the possible additional query terms (e.g., attributes), segregation of the additional attributes according to categories, presentation of the songs being played back, and interactive components that enable real-time adjustment of queries and their resulting play lists (e.g., based on user feedback and interaction).

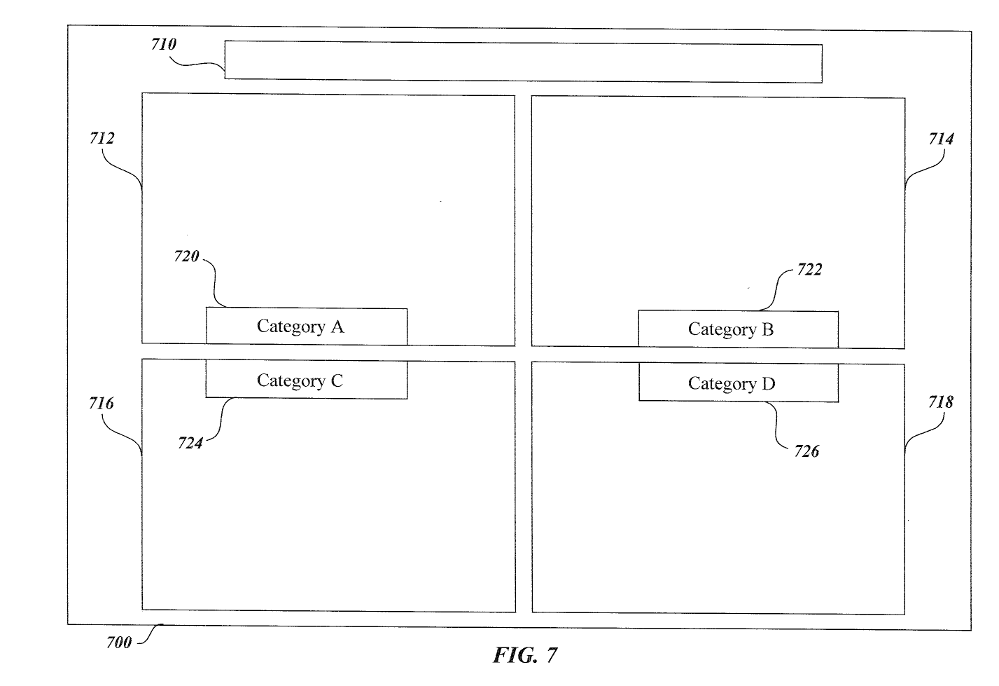

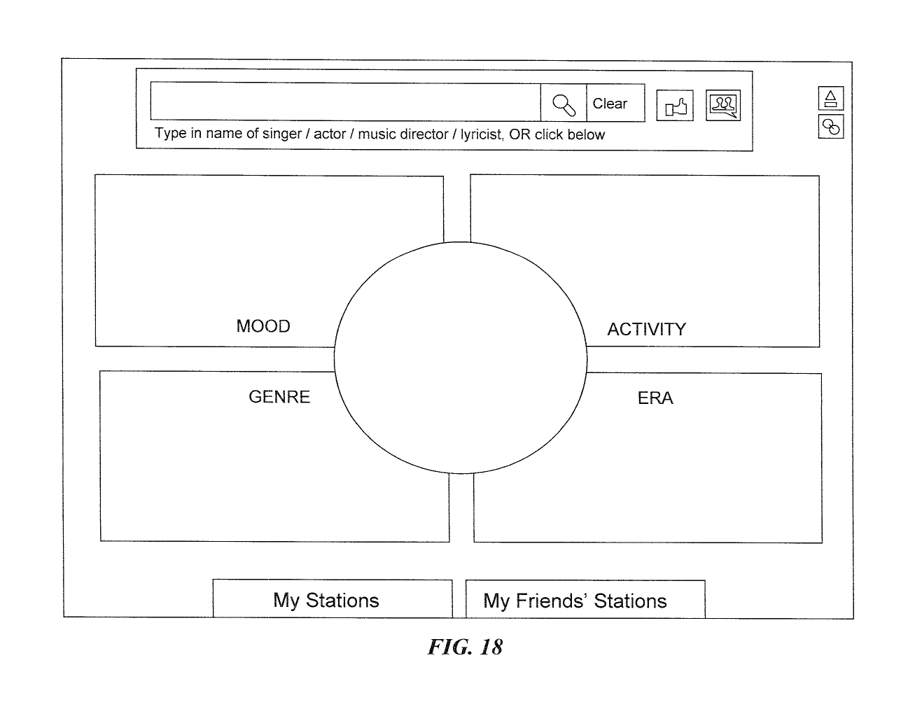

Example embodiments of a computer implemented information display 700 according to aspects of the present invention are depicted in FIGS. 7 through 16. Preferably, the display 700 is generated as a graphical user interface (GUI) and presented to a user at a client workstation 154 on an illustrative website via an internet network connection. Screen shots of the illustrative website are depicted in FIGS. 18 through 28.

FIG. 7 illustrates the example display 700, as presented to a user at a client workstation 154 prior to the step 610 of receiving a first attribute for defining the first active search query. The display 700 includes four category indicators depicted by blocks 712, 714, 716, and 718. Included in each category indicator 712 through 718 are category labels 720, 722, 724, and 726. In an illustrative embodiment, when the display initially loads without an active search query having been defined or generated, the four category indicators 712 through 718 do not represent the “Person” category. However, “suppressing” (e.g., not representing on the display 700) the “Person” category is merely illustrative. Other categories can be suppressed (e.g., not representing on the display 700) upon initially loading the display 700. The display 700 also includes a search entry field, such as a search bar 710, for receiving and displaying search terms (e.g., attributes) that define queries used to generate play lists for recommending performances to the user's workstation 154. The search bar 710 can be accompanied by a displayed set of instructions indicating to a user what search terms can be entered into the search bar 710.

FIG. 8 is a diagrammatic illustration of the example display 700 subsequent to receiving a first attribute from a user, generating a play list, and initiating playback of a song on the play list. In addition to the features and elements depicted in FIG. 7, display 700 also includes a playback indicator 738, located in the center of the display 700. The example playback indicator 738 includes an outer ring portion 778, which can overlap with the four category indicators 712 through 718 and includes four attribute indicators 740, 742, 744, and 746. The four attribute indicators 740 through 746 are located within their respective category indicator 712, 714, 716, or 718, and display attributes of the song being played and that are associated with the four displayed categories 712 through 718. In addition to attribute indicators 740 through 746, there are attribute indicators 730a, 730b, 732a, 734a, 734b, 736a, 736b, and 736c. These attribute indicators 730a through 736c display one or more attributes of remaining songs in the play list that are not currently being played and displayed by the playback indicator 748. These attributes are positioned within their associated categories 712 through 716 on the display.

While the outer ring portion 778 as illustrated only includes one attribute indicator 740 through 746 per category 712, 714, 716, or 718, multiple attribute indicators can be included. For example, if a song being played has two attributes associated with the category “Mood” (e.g., the attributes “Romantic” and “Happy”), then two attribute indicators will appear in the outer ring portion 778, and both will be positioned within the category indicator 712, 714, 716, or 718 that represents “Mood.”

Notably, as depicted by FIG. 8, the illustrative display 700 visually segregates attributes that are associated with the song currently being played from the attributes associated with additional songs on the play list that are not currently being played. However, all of the attributes are displayed as being associated with a particular category, regardless of whether the attributes are of a currently playing song or are of an additional song on the play list that is not currently being played. In an illustrative embodiment, the display 700 presents all of the attributes of all of the songs on the play list that are associated with a displayed category. The attribute indicators 730a through 736c and 740 through 746 can be displayed as graphical, non-text icons, such as a picture that adequately represents the attribute, and can also be displayed as text strings. For example, an icon of smiley face can be the first-level attribute indicator for the attribute, “Happy.” Similarly, an icon of a rose can be the first-level attribute indicator for the attribute “Romantic.” Additionally, the first level attribute “Composer” can be represented by an attribute indicator containing the text “Composer.” The display 700 need not be limited to a single type of representation of the attributes. Rather, different attributes can be presented and represented by different display features. In some instances, attributes can also be represented based on audio presentations. For example, scrolling over a particular attribute indicator can result in the attribute represented by the indicator being read along over one or more speakers.

As described herein, an “attribute indicator” is a display feature, e.g., an object, entity, portion thereof, color thereof, etc., that is illustrated or graphically depicted on a display. An attribute indicator displays or represents information about an attribute. Similarly, a “category indicator” is a display feature that displays or represents a category. Thus, proper usage of the above terms is to characterize indicators as entities on a display that represent information, and to characterize attributes and categories as characteristics or qualities, which can be represented by the displayed indicators. Said differently, attributes and categories are characteristics that are displayed by indicators. Accordingly, various reference numerals depicted in FIGS. 7 through 16 and referred to herein designate both the indicator and the associated information being represented. For example, reference number 712 can refer to a particular category indicator, a particular category, or both, depending on the context of the sentence in which it is used. This is true for all indicators and the corresponding information they represent, and not just attribute indicators or category indicators.

Other display mechanisms besides placement within the category indicators 712 through 718 can be utilized to indicate with which categories the attribute indicators 740 through 746 are associated or belong. In alternative embodiments, the playback indicator 738 is not located in the center as a circle, but rather is located elsewhere and shaped differently, e.g., as a rectangle. As such, attribute indicators 740 through 746 are visually associated with their respective category indicators 712 through 718 by lines or other connectors. In yet additional alternative embodiments, association between attribute indicators 740 through 746 and category indicators 712 through 718 is displayed using color coordination. Similarly, association of attributes with the current playing song may be depicted using color coordination, connectors/lines, and other visual highlights, rather than placement within the outer ring 778. Furthermore, other mechanisms of displaying association are possible and contemplated within the scope of the invention.

In the center of the playback indicator 738 is current file indicator 748, which displays identifying information about a song that is being played. In the illustrative embodiment pertaining to audio music files, the identifying information can include the title of a song being played, information regarding the length of the song being played, and information about the amount of time that has elapsed in the song being played. As new songs from a play list are loaded and commence playback, the identifying information in the current file indicator 748 changes. Forward button 750 and backward button 752 optionally can be included, in order to allow the user to scroll through the play list as desired.

As depicted in FIGS. 7 and 8, only four of the category indicators 712, 714, 716, and 718 are included in the illustrative display 700. More or less categories can be represented by the addition of additional category indicators or the subtraction of depicted category indicators. The category indicators need not be shaped as rectangles, and they need not have a box/rectangular layout as depicted in FIGS. 7 and 8. Alternative shapes and configurations can be used, particularly when adding to and subtracting from the number of categories represented on the display. In particular, as more categories are added, it may be desirable to display the various category indicators as pieces of a pie, which collectively form a pie shape.

Accordingly, the system 100 can automatically display a predetermined number of the category indicators (e.g., 1, 2, 3, 4, 5, 6, 7, 8, 9, 10, etc.). Additionally, the system 100 can selectively choose which categories will be displayed by the four category indicators 712, 714, 716, and 718 at any given time. In an illustrative embodiment, the four categories that are represented on the display can change, but are always chosen from a group of five fixed categories, as previously described herein. In an illustrative embodiment, the five fixed categories include “Mood,” “Genre,” “Era,” “Person,” or “Activity.” Therefore, four of these five categories are always represented by the four category indicators 712, 714, 716, and 718, while one of these five categories is always hidden and unrepresented by the aforementioned category indicators. Thus, in such embodiments, the five categories are fixed, but the particular category that is hidden/suppressed (e.g., not represented in the display) can change as desired, for example, based on the active search query. Furthermore, in some embodiment, the 5 fixed categories may be selected by the user (e.g., via received user feedback, via explicit or implicit user preferences, via user trends/histories, etc.) from an overall set of categories containing many more than five categories. For instance, the system 100 can enable a user that is uninterested in the “Activity” category to replace it with a different category, such as “Tempo.”

Notably, aspects of the present invention involve the recognition that it can be desirable to hide the category associated with the first attribute 762. This can be particularly beneficial when the goal of the system 100 is to enable the user to explore new recommendations based on previously unsearched characteristics or attributes.

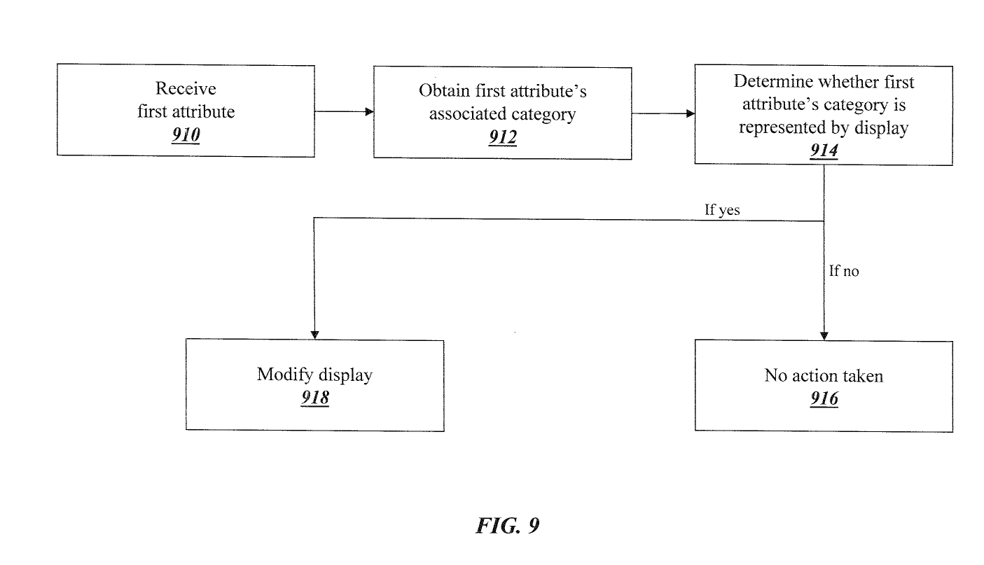

FIG. 9 depicts a method for automatically hiding the category associated with the first attribute 762, according to aspects of the present invention. The client communications module 148 receives a first attribute 762 selected by the user (step 910). The visualization controller 110 then uses the received first attribute 762 and obtains the one of the five categories that is associated with the first attribute 762 (step 912).

The visualization controller 110 determines whether any of the category indicators 712, 714, 716, and 718 originally presented to the user (and depicted in FIG. 7) represents the obtained category associated with the first attribute 762 (step 914). If the determination is “no,” then the visualization controller 110 does nothing (step 916). On the other hand, if one of the category indicators 712, 714, 716, or 718 does represent the obtained category associated with the first attribute 762, then the visualization controller 110 modifies the display 700 of FIG. 7 (step 918). Specifically, this modification entails fading out the category label and category indicator associated with the first attribute 762 and simultaneously fading in a new category label and category indicator displaying the formerly unrepresented category of the five fixed categories.

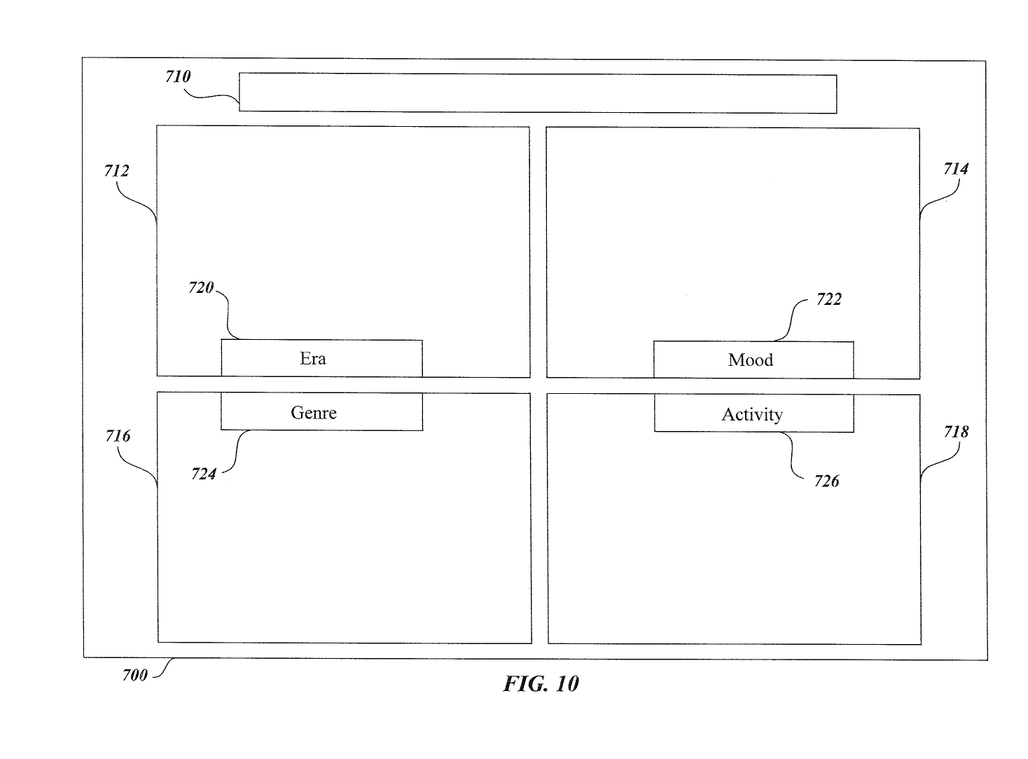

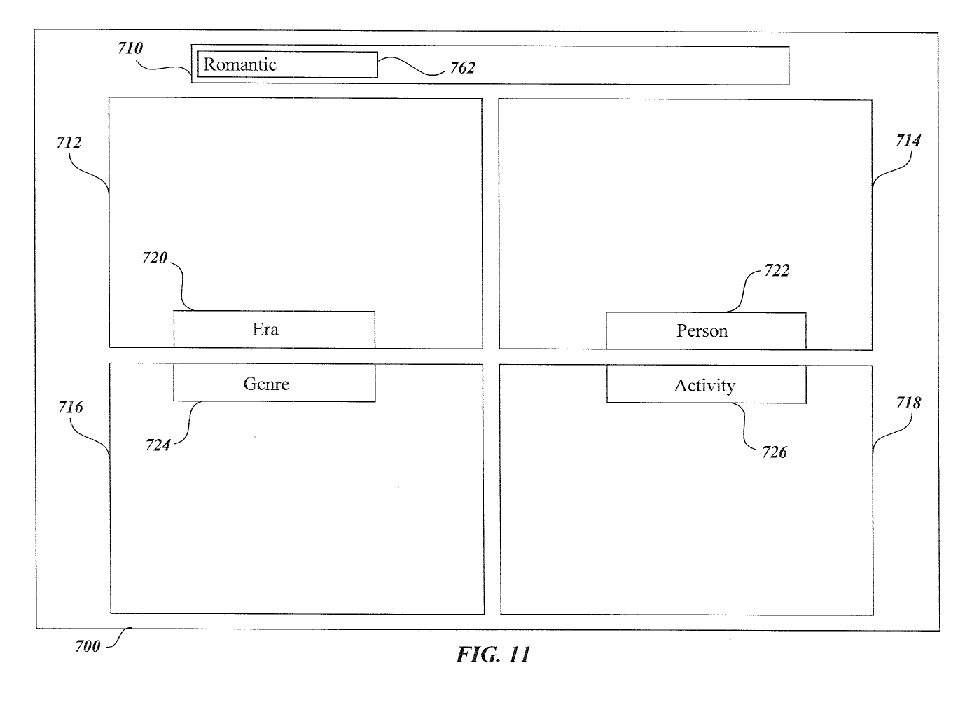

Therefore, if a user submits a first attribute 762 (e.g., in isolation without any other submitted attributes), then the illustrative display 700 will automatically hide the category that includes the desired attribute (i.e., the category with which the received first attribute 762 is associated). This is illustrated in the example depicted in FIGS. 10 and 11. The user is presented with the display 700 of FIG. 10, which has four category indicators representing the categories “Era” 712, “Mood” 714, “Genre” 716, and “Activity” 718. The user inputs the attribute “Romantic” into the search bar 710 and then submits “Romantic” as the first attribute 762. (For instance, the user manually enters “Romantic” using a keyboard and subsequently clicks a submit button.) The system 100 then produces recommendations of songs that all have the characteristic of being romantic. Upon receiving the first attribute 762, the system 100 will obtain the category with which this attribute is associated. In this example, the category associated with “Romantic” is “Mood.” Next, the visualization controller 110 determines that “Mood” is represented on the display 700, and thus fades out the “Mood” category indicator 714 and the corresponding category label 722. Simultaneously, the category indicator and corresponding category label for “Person” fade in, since this category was previously unrepresented. Once the modification to the display 700 is completed, the user will be presented with the display 700 illustrated in FIG. 11, which depicts “Person” in place of “Mood,” as well as the attribute “Romantic” in the search bar 710.

Using this fading feature, the particular categories that are displayed at any one time can be changed through a process of replacement. Fading in and fading out is one example of such a process for replacing displayed categories with non-displayed categories. Furthermore, replacing a visually represented category with a visually unrepresented category in this manner also can include moving the position of all or some of the category indicators 712 through 718. For example, the display 700 can be configured such that when the “Person” category is displayed, it is always displayed in the bottom right hand corner of the box configuration. An alternate example rule is that the display 700 always replaces the fifth category (which is originally hidden and not represented on the display 700) with the category associated with the first attribute 762 (i.e., the first attribute that is searched). Other similar rules can be guide the automatic placement and replacement of the category indicators 712 through 718. Thus, these and/or other rules for (or alternatively, random movements of) determining a placement of the category indicators 712 through 718 can be included in the process of replacing a visually represented category with a visually unrepresented category indicator.

Similarly, when an active search query is modified, the categories that are automatically represented by the system can change. Consider an active search query containing two attributes, “Romantic” and 1970s,” associated with two different categories, “Mood” and “Era,” respectively. Furthermore, consider that “Mood” is not represented by any of the displayed category indicators. If the user removes “Romantic” from the search bar 710, thereby removing this attribute from the active search query, then the only remaining attribute in the search bar 710 is “1970s.” Therefore, the only category associated with the active search query is “Era.” However, in this example, “Era” is represented by one of the four category indicators. Thus, the system 100 automatically detects the category indicator, in the manner described previously herein, and replaces the displayed “Person” category indicator with a “Mood” category indicator, and also replaces the displayed “Era” category indicator with a “Mood” category indicator, thereby leaving four categories represented: “Mood,” “Genre,” “Person,” and “Activity.”

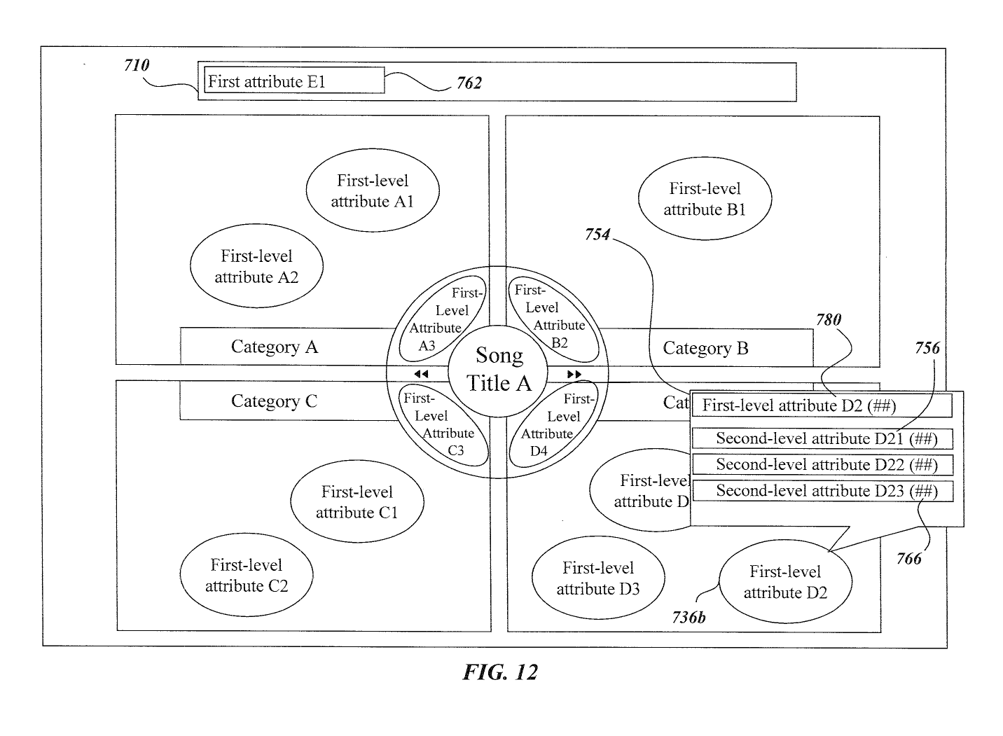

Embodiments of the present invention can include additional display features that enable additional user interaction with the illustrative display 700. The additional features can enable further visual segregation of organizational information, as described herein. Additional display features are illustrated in the example displays 700 of FIGS. 12 through 16.

FIG. 12 depicts an attribute pop-up window 754. In the illustrative embodiment, one or more of the first-level attribute indicators can be selectable by a user, upon the user issuing a proper command. By selecting a first-level attribute indicator, the attribute pop-up window 754 appears on the display 700. As shown in FIG. 12, second-level attribute indicators 756 are located within the attribute pop-up window 754. A selected first-level attribute indicator thus presents one or more second-level attribute indicators 756 associated with or further defining the selected first-level attribute 736b. First-level or second-level attributes that are not found in the play list are not displayed.

In an illustrative embodiment, the second-level attributes displayed in the attribute pop-up window 754 can be text strings that spell out the particular second-level attribute in a given language. In addition, the attribute pop-up window 754 can include, at the top of the list of the second-level attributes, a first-level attribute indicator 780 that is a text string spelling out the selected first-level attribute. In this manner, a given first-level attribute can be displayed by the first-level attribute indicator 736b which is a non-textual icon, and it can also be displayed by the first-level attribute indicator 780 which is a textual icon.

Second-level attribute indicators such as indicators 756 can also be organized, shaped, located, and visualized in other manners. For example, alternative embodiments do not display second-level attributes in a pop-up window such as the example attribute pop-up window 754. Rather, the second-level attribute indicators 756 can be included in the display 700 at all times when the represented second-level attributes are present in the play list. Furthermore, the second-level attribute indicators 756 can be included in a different panel (e.g., a side panel) as indicators that appear when the user “mouses over” a first-level attribute indicator such as the first-level attribute indicator 736b. As yet another possibility, the second-level attribute indicators can be located within or otherwise associated with the appropriate category indicators in the same manner as first-level attribute indicators. In such embodiments, lines, connectors, color coordination, and other known display mechanisms for displaying association can be used to indicate that a second-level attribute is associated with or belongs to a first-level attribute.

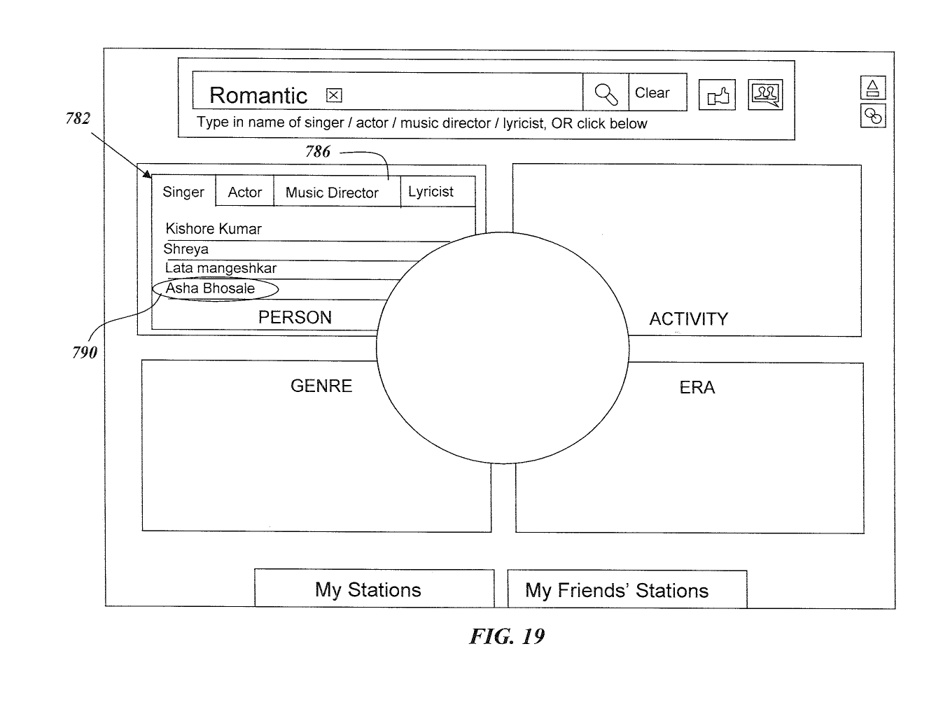

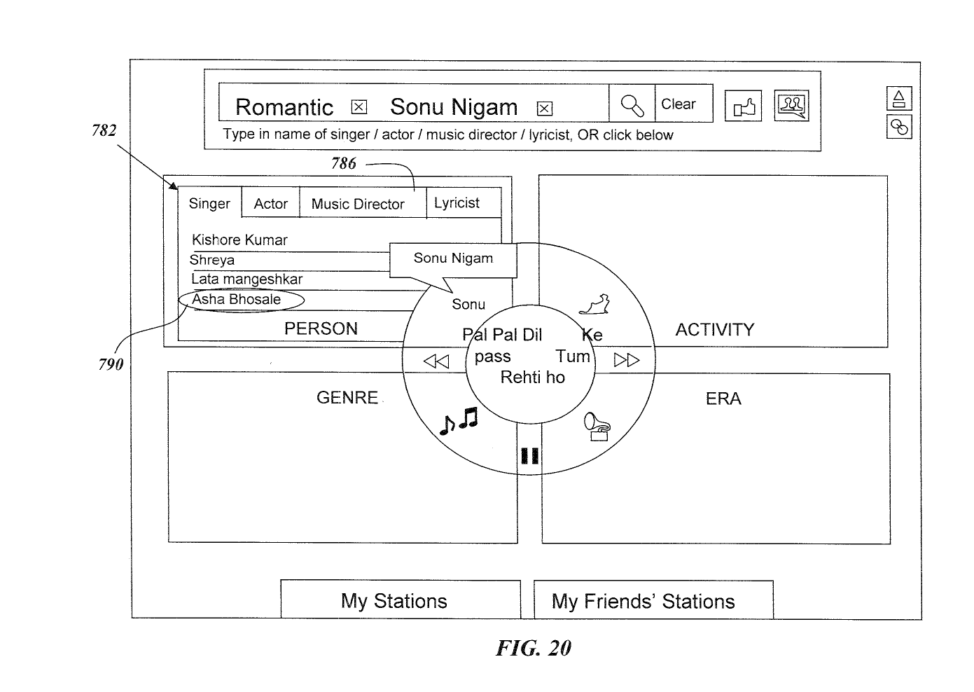

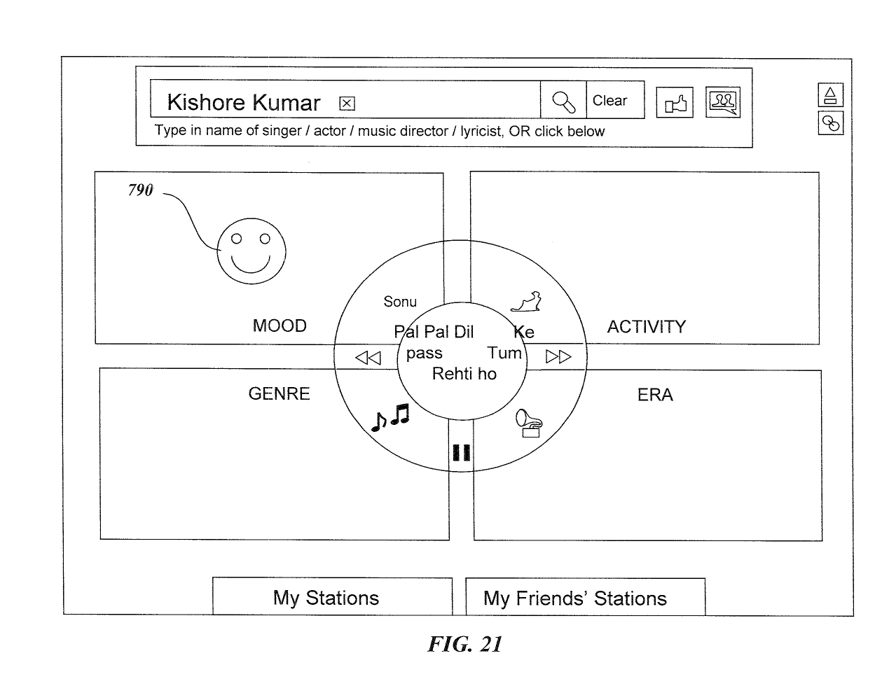

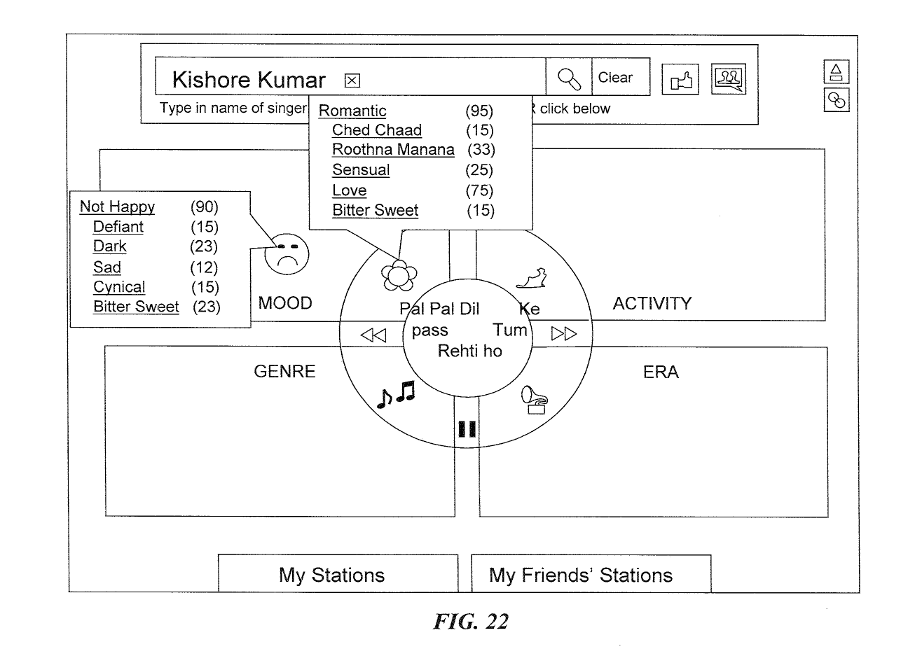

Furthermore, the particular display, layout, and configuration that is used for presenting second-level attribute indicators can vary from category to category. For example, the second-level attribute indicator window 782 depicted in FIGS. 19 and 20 for the category “Person” is distinctly different from the attribute pop-up window 774 of FIGS. 21 and 22. For instance, the second-level attribute indicator window 782 includes the tabs 786. Furthermore, in illustrative embodiments, and unlike the pop-up window 774, the tabs 786 are always displayed whenever the “Person” category is displayed. Thus, the tabs 786 are not pop-up windows, but rather can be permanent display features for the “Person” category.

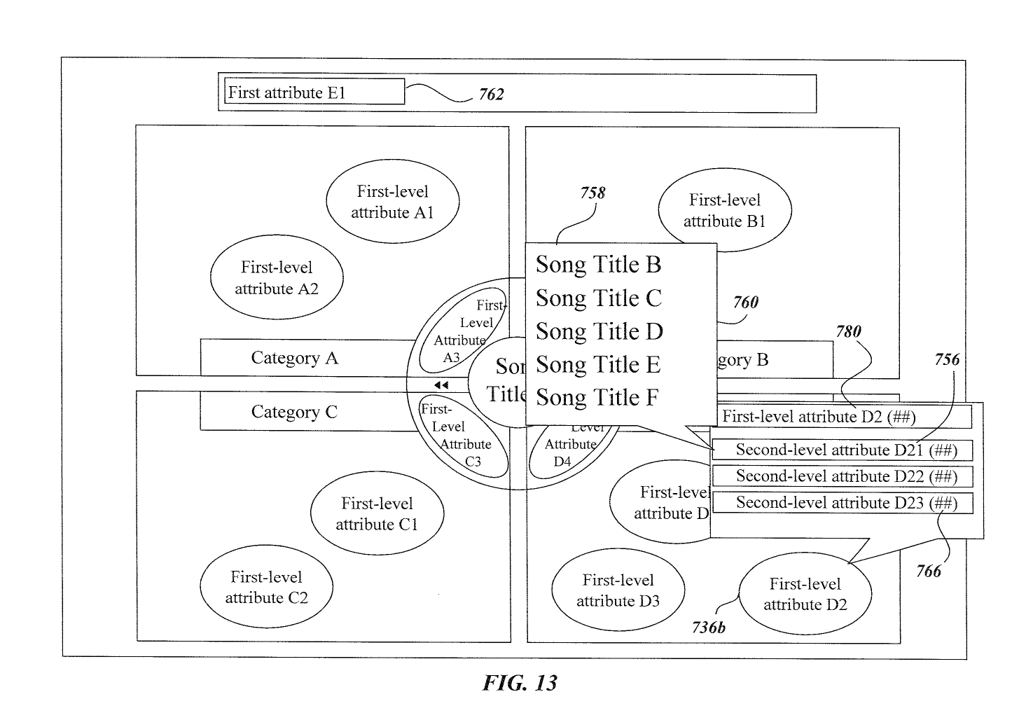

FIG. 13 displays a song list pop-up window 758, an additional display feature that can be implemented in embodiments of the present invention. In an illustrative embodiment, one or more of the first-level or second-level attribute indicators 756 can be selectable by the user upon issuing a proper command. Once the user selects one of the attribute indicators 756, an additional pop-up window 758 can be displayed which includes one or more song indicators 760. In this example where a second-level attribute has been selected, the song indicators 760 display identifying information of one or more of the songs that possess, as characteristics, both the selected first-level attribute 736b and the selected second-level attribute 756. In effect, the song list pop-up window can display to the user a play list that will result from an active search query that includes the selected first-level attribute 736b, the selected second-level attribute 756, and the first attribute 762.

In embodiment having second-level attribute indicators (examples of which are illustrated both in FIGS. 12 and 13), one or more of the second-level attribute indicators 756 can include, in parentheses, a number indicator 766. The number indicator 766 displays the quantity of songs that possess both the submitted first attribute 762 and the second-level attribute with which the number indicator is associated. This feature provides users with additional information regarding the how many recommendations are available for a given active search query or set of attributes.

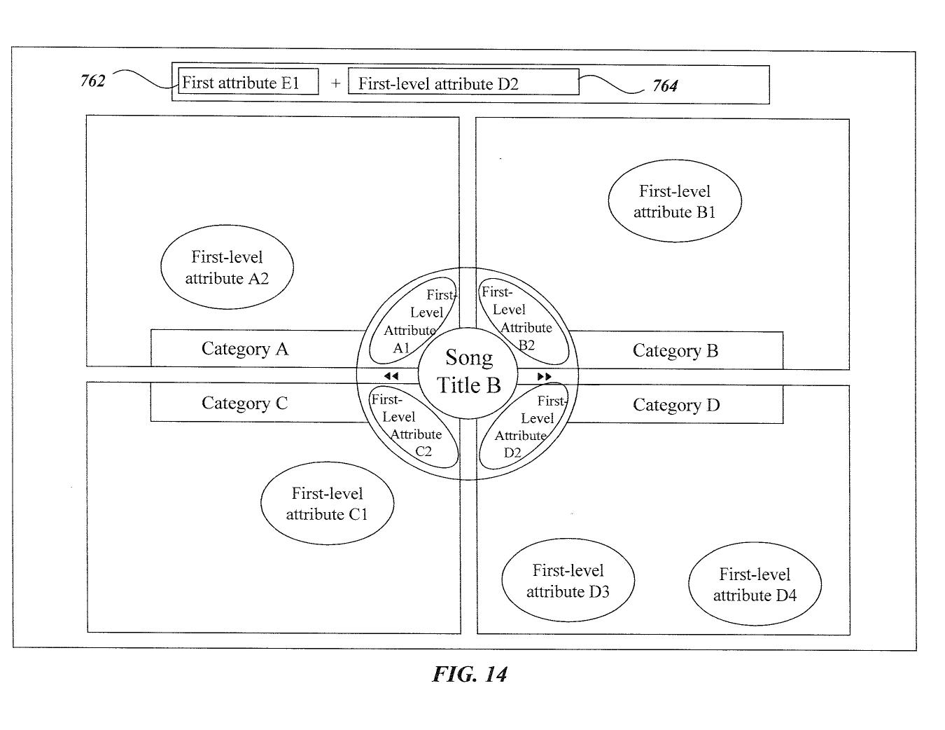

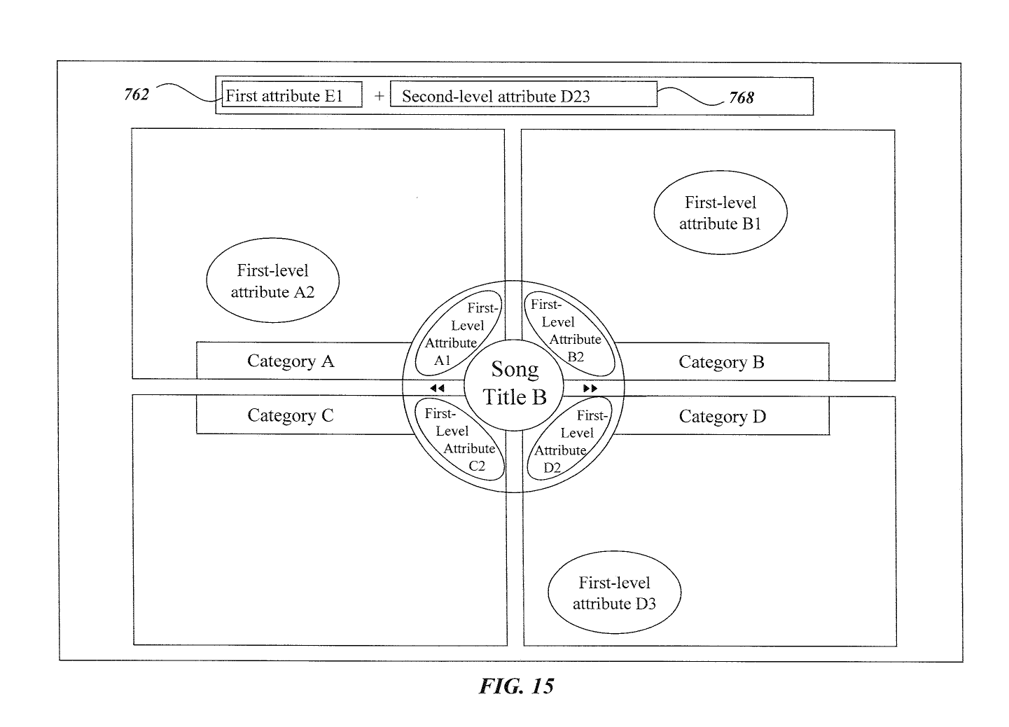

FIGS. 14 and 15 illustrate features that enable the user to refine the active search query in real-time and adjust the performance recommendations based on additional and subsequent selections of displayed attributes.

Upon issuing one or more proper commands, a user can add first-level or second-level attributes to the search bar 710. FIG. 14 displays a scenario arising from a user issuing the proper command to add a first-level attribute 736b from FIG. 13 to the search bar 710. Upon issuing the proper command, the corresponding first-level attribute 764 appears in the search bar 710, as depicted in FIG. 14. Then, a second active search query is generated automatically from the newly-added first-level attribute 764, and the play list subsequently updates, as described previously. Since the updated play list is based on an active search query that includes an additional search string (i.e., the attribute 764), the set of attribute indicators included in the display 700 of FIG. 14 is fully contained within the set of attribute indicators included in the display 700 of FIG. 13.

In addition to adding a first-level attribute to the search bar 710 (as depicted in FIGS. 13 and 14), a user can also add a second-level attribute to the search bar 710, as illustrated in FIG. 15. By selecting the first-level attribute indicator 736b from FIG. 13, the attribute pop-up window 754 appears. Next, the user can add a second-level attribute 768 shown in FIG. 15 to the search bar 710 by issuing the proper command to one of the second-level attribute indicators 756 included on the display 700. The active search query then is automatically defined to include the second-level attribute 768, and the play list is automatically updated. As depicted in FIGS. 14 and 15, it is assumed for purposes of simplicity that the same song begins playing in both instances. However, given that the active search query used to generate the play list of FIG. 15 is narrower and defined by more text strings than the active search query used to generate the play list of FIG. 14, there may be fewer songs in the play list of FIG. 15. Thus, there may be fewer attributes displayed in FIG. 15 as compared with FIG. 14, and as depicted by the presence of fewer attribute indicators.

It is worth noting that while a user can command a second-level attribute to be added to the search bar 710, the resulting attribute indicators 740, 742, 744, and 746 still display first-level attributes. In alternative embodiments, selecting a second-level attribute indicator can result in the corresponding attribute indicator 740, 742, 744, or 746 displaying the selected second-level attribute. In embodiments provided herein, attribute indicators 740, 742, 744, and 746 can be selectable and configured to display additional display features such as attribute pop-up window 754 and song list pop-up window 758, as previously described herein.

Additionally, in some embodiments, a user can be enabled to choose a song for playback by directly selecting a song indicator 760 from the song list pop-up window 758. Selecting a song indicator 760 can cause a number of actions to occur, including initiating playback of the song itself. Furthermore, such selection optionally can cause the corresponding first-level attribute associated with the song list pop-up window 758 to be added to the search bar 710, thus triggering generation of a new active search query. Alternatively, such selection of a song indicator 760 can optionally cause the corresponding second-level attribute associated with the song list pop-up window 758 to be added to the search bar 710.

Subsequent to attributes being added to the search bar 710 and search strings being added to the resulting active search query, attributes can be removed from the search bar 710. In illustrative embodiments, a button appears next to each attribute in the search bar 710. The button contains, e.g., an “X,” and upon clicking or otherwise selecting the button, the associated attribute is removed from the search bar 710. Alternatively, attributes that have been added to the search bar can be removed by the user striking a “delete” key on a keyboard. Removing an attribute from the search bar 710 results modifying the active search query to define parameters of a play list that are defined only by the remaining attributes in the search bar 710. Given the automation of the system 100, changing an existing active search query or defining a new active search query automatically results in a new play list being generated. The resulting generated new play list is a modification of the previously existing play list. If no attributes remain in the search bar 710 subsequent to removal of an attribute, then no active search query is defined, and no play list is generated. This is also true if the user selects a button such as a “Clear” button that automatically clears out all of the contents of the search bar. In such scenarios, an “open” active search query can be generated that contains no search terms and is defined by no attributes. Thus, in such embodiments, an “open” play list is generated that includes all of the available songs in the song database 156. Alternatively, in such scenarios, the former play list can be aborted (i.e., playback can be terminated) and the playback indicator 738 can be removed, e.g., by fading out. Therefore, in the illustrative embodiment, the display 700 appears as depicted in FIG. 7 whenever an active search query has not been defined. However, in alternative embodiments, the playback indicator 738 can be present at all times, regardless of whether an active search query has been defined. In yet additional alternative embodiments, the playback indicator 738 can appear and disappear in other ways, depending on other factors distinct from the existence of an active search query.

For example, in some embodiments, the display 700 can be loaded by the user as a web application that is hosted by a third-party website, and can display the playback indicator 738 immediately upon loading. In such embodiments, an active search query can be automatically generated, and playback of the resulting play list can be immediately initiated, one song at a time. The automatically generated active search query can be based on implicitly learned preferences of the user, can be based on a particular play list that has been shared (e.g., via social media applications) by another user, can be based on a play list that was engaged in playback during a previous session of the user, or can be based on other factors.

All of the display features described herein, unless activated by a user command or otherwise indicated by context, can be fully automated, as would be appreciated by one of skill in the art upon reading the present specification. Furthermore, regarding user commands, one of skill in the art will appreciate that many different keystrokes, mouse clicks, voice commands, and other functions related to making a selection can be assigned to the various user commands. In an illustrative embodiment, a user can add a first level attribute to the search bar 710 by double clicking the corresponding first level attribute indicator. A user can display an attribute pop-up window 754 containing second-level attribute indicators 756 by scrolling over the first-level attribute indicator. A user can select a song list pop-up window 758 containing song indicators 760 by clicking on a second-level attribute indicator 756. A user can add a second-level attribute to the search bar 710 by double clicking the corresponding second-level attribute indicator. All such commands, including commanding an attribute to be added to the active search query and commanding a pop up window to be displayed, are herein referred to as “selecting.” Furthermore, all such indicators, displayed categories, displayed attributes, and other display features that are capable of being selected are herein referred to as “selectable.”

In addition, the user can input an attribute into the search bar 710 in a number of different ways, including by striking the keys of a keyboard connected to I/O port of the user's client workstation 154. The user then can submit the selected attribute by pressing enter, clicking on a “submit” button or a “search” button, or any other known mechanism for allowing submission of information over a network.

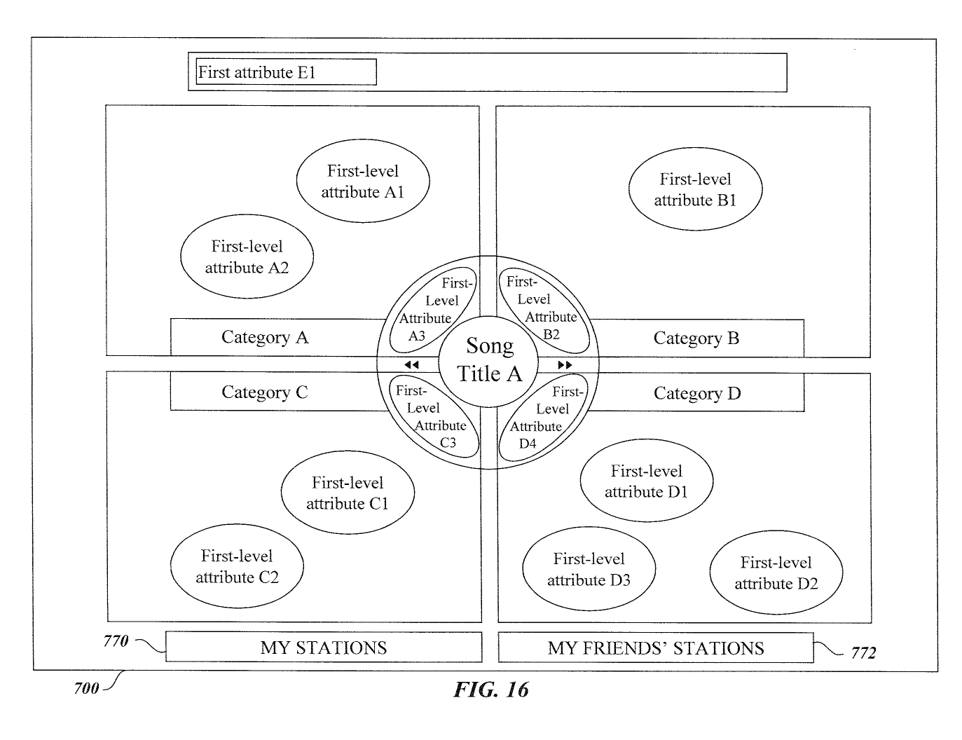

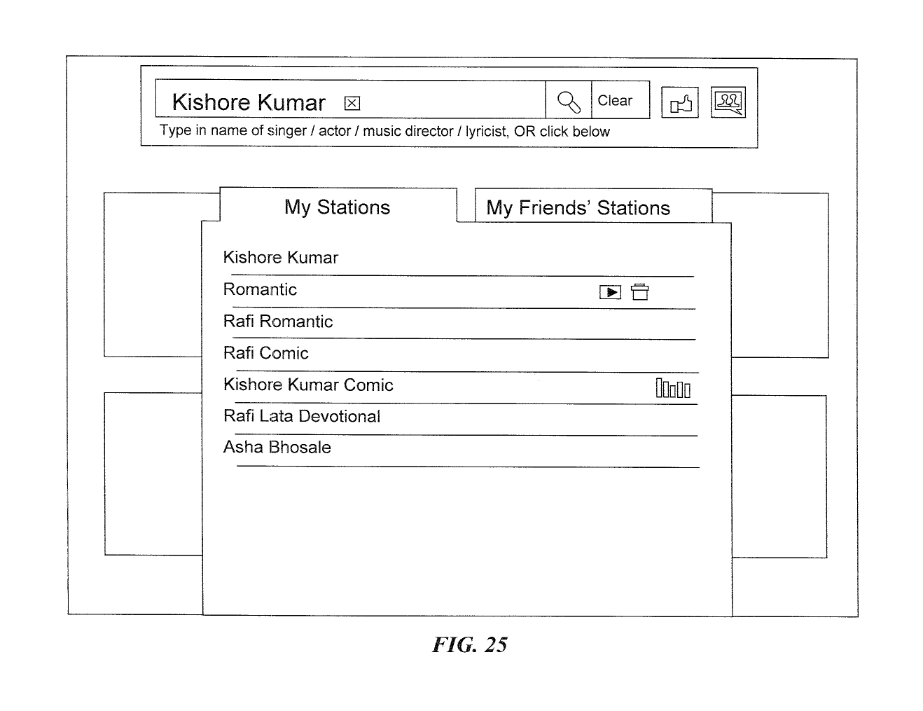

The display 700 can be used in conjunction with user accounts. By registering for an account, a user can be enabled to save specific play lists or to save active search queries, as desired. Preferably, the system 100 only allows active search queries to be saved by a user. Saved active search queries, herein referred to as “Stations,” can be saved on a server or other non-transitory computer-readable medium. As shown in FIG. 16, users with registered accounts can log in using an authentication website, and can subsequently be presented with additional “My Stations” button 770 and “My Friends' Stations” button 772. Selecting button 770 can enable an additional display (depicted in FIG. 25) to appear that allows users to save new stations, view saved stations, recall saved stations, rename saved stations, and other known functions related to saving and opening files. Selecting button 772 can enable an additional display to appear that allows users to view and select/play the stations saved by other users (“friends”). The list of friends is retrieved by connecting to popular social networks. Selecting a friend's station will result in the active search query or attributes that define the selected friend's station to be added to the search bar 710, resulting in playback of the play list characterizing the selected station. Such a sharing feature can be used in conjunction with social networks and can enable a broader range of communication between users, which allows for additional avenues by which a user can receive recommendations for music (e.g., from a friend). As such, embodiments of the present invention are compatible with such social networks and can be implemented to provide a wide variety of sharing features. This can include, as an example, sharing particular songs, sharing particular stations, sharing particular queries, sharing particular attributes, and the like.

In further embodiments of the present invention, the current file indicator 748 can be selectable, e.g., by scrolling over the indicator 748 with a mouse (“mousing over”). Upon selecting the current file indicator 748, a trivia pop-up window 776 can be presented on the display 700. The trivia pop-up window 776 can include trivia information about the song that is currently being played.

In yet further embodiments of the present invention, alternative attribute pop-up windows can be implemented. In general, the particular display layout of the attribute pop-up windows can be customized based on the particular category associated with the selected attribute. Furthermore, attribute pop-up windows can display a list of first-level attributes alone, second-level attributes alone, or a combination of first and second-level attributes. One or more first-level attributes indicators can be displayed as tabs such as tab 786, as depicted in FIG. 19. Preferably, each of the four first-level attributes 786 can be selected (e.g., via clicking) to display a second-level attribute indicator window 782 containing one or more second-level attributes 790. In some embodiments if there are no second-level attributes for a given first-level attribute, then the first-level attribute can be excluded from the one or more displayed first-level attributes, (e.g., from the tabs 786). In such embodiments, the display 700 can exclude the feature of enabling the one or more first-level attributes 786 (e.g., “Singer,” “Actor,” “Music Director,” and “Lyricist”) associated with the category “Person” to be added to the active search query. In such embodiments, the display 700 and system 100 can prescribe that only the second-level attributes for the category “Person” can be added to the active search query.

While many different types of categories, attributes, and levels of attributes can be implemented with the illustrative embodiment, the following tables represent the categories, first-level attributes, and second-level attributes that preferably are used. In each table shown below, the first row indicates the category, the second row indicates the various first-level attributes, and all subsequent rows indicate the various second-level attributes associated with the above listed first-level attribute. These choices of categories and attributes are in no way limiting. Rather, they are presented merely for purposes of illustration.

TABLE I
Category I: MOOD

| Romantic | Happy | Unhappy | Devotional | Sentimental |
|---|---|---|---|---|
| Ched Chaad | Holi | Defiant | | Patriotic |
| Roothna | Birthday | Dark | | Philosophical |
| Manana | | | | |
| Sensual | Wedding | Sad | | Nostalgic |
| Love | Comic | Cynical | | Family Love |
| Bitter | Inspirational | Bitter | | Friendship |
| Sweet | | Sweet | | |

TABLE II
Category II: GENRE

| Geet | Dance | Western | Apni Parampara |
|---|---|---|---|
| Children | Item | Jazz | Semi-classical |
| Lullaby | Mujra | Spanish | Ghazal |
| Instrumental | Disco | Rock | Qawwali |
| | | Rock n' Roll | Sufi |
| | | | Folk |

TABLE III
Category III: ERA

| | | | | |
|---|---|---|---|---|
| Till 1969 | 1970-1990 | 1990s | 2000s | Latest |

TABLE IV
Category IV: PERSON OR ENTITY

| | | | |
|---|---|---|---|
| Singer | Actor | Music Director | Lyricist |

TABLE V
Category V: ACTIVITY

| Working | | | |
|---|---|---|---|
| Out! | All By Myself | With Friends & Family | Make My Day! |
| | Just Relaxing | With That Special | House-Work |
| | | Someone! | |
| | Meditating | Dance Party! | Bored at Work |
| | Praying | Putting Kids to Bed | |

While some of the first-level attributes are shown as not having associated second-level attributes, one of skill in the art will readily appreciate that the entries for second-level attributes can be added easily upon examining the particular collection of songs. For example, information regarding “Singers” can depend on the particular song performances that are included in the collection or databases 156.

Many alternative embodiments are possible and contemplated within the scope of the present invention. Particularly, the display 700 optionally can populate the category indicators 712, 714, 716, and 718 of FIG. 7 with all or some of the available first, second, and higher-level attributes prior to receiving any first attribute from the user. Furthermore, in alternative embodiments involving pre-population of the category indicators 712 through 718, a user can submit a desired first attribute for active search query generation simply by selecting the appropriate attribute indicator. As described previously, selecting the attribute indicator can result in the system 100 automatically adding the selected attribute to the search bar 710. Additionally, in such embodiments, selecting and submitting the first attribute indicator can cause submission of the category associated with the selected first attribute. In such instances, the visualization controller 110 obtains the category associated with the first attribute simply by receiving it from the client workstation 154.

In yet additional alternative embodiments, the playback indicator 738 of FIG. 8 can automatically appear prior to the generation of any first play list or the initiation of playback of a first song. In such alternative embodiments, the current file indicator 748 does not contain any information initially, since no song is currently being played prior to generation of a first play list.

In yet additional alternative embodiments, the system 100 can be configured to automatically begin playing a welcome audio recording. The welcome audio recording can be played upon initiation of a new session by a newly registered, existing, or unregistered user. The welcome audio recording can include instructions for operating the display in order to produce recommendations of performances possessing desired characteristics.

In yet additional alternative embodiments, songs are classified and indexed according to attributes belonging to more than five categories. In such embodiments, the user can be enabled to choose which categories are represented on the display 700. Furthermore, categories that are not represented on the display 700 (i.e., categories that are “hidden”) can nevertheless serve as a basis for recommending music or other types of performances. For example, such additional categories and attributes can provide variety in the degree of similarity between recommended performances. If a higher degree of similarity is desired, additional attributes belonging to hidden categories can be added to the active search query. Additionally, as described previously, matching logic can be utilized that is based on user feedback (e.g., obtained via a “Like” feature) in order to improve song relevance ranking and play list order on a per-user basis. Such additions to the active query can be displayed on the search bar 710 if so desired, or can be hidden from the search bar 710. Furthermore, the particular attributes that are added to the active search query can be random, can based on user preferences, can be based on implicit relevance matching, can be based on choosing more/less common categories, and/or can be based on other criteria.

In yet additional alternative embodiments, the first attribute 762 that is submitted to the system 100 is not submitted by the user. Rather, the first attribute 762 can be selected by a system administrator, can be selected based on a pre-existing user profile containing user preferences, or can be selected based on a particular selection history. In the example embodiment described herein, all performances are pre-recorded audio music files. However, any type of media files can be used in addition or as alternatives. Embodiments of the present invention are not in any way limited to songs or music files containing songs. Any media file displaying any type of performance can be used.

While one benefit of the illustrative embodiment is to provide additional control to users over the particular types of recommendations they receive, embodiments of the present invention are nonetheless compatible with features related to implicit relevance matching and systems that utilize automated learning and recommendation based on user histories. Such systems for recommending performances can be used in conjunction with the illustrative embodiment. As such, additional buttons and display features can be added to the display 700 to enable users to provide feedback regarding enjoyable songs, enjoyable play lists, etc. Such additional buttons can include a “Thumbs up” or “Like” button, and a “Thumbs down” or “Dislike” button. Alternatively, an optional scale indicator can allow users to submit feedback regarding particular songs, play lists, attributes, etc.

As one example of the way in which automated recommendation systems can be combined with the illustrative embodiment, additional categories and/or characteristics of songs can be provided and hidden from users. Such additional characteristics can be used to further refine the play lists generated by user preferences (e.g., one or more selected attributes). In other embodiments, queries can be generated that use both user-inputted attributes and system-inputted attributes. The system-inputted attributes can be automatically generated by the system and can be based on a single user's history or many users' histories. For example, if the system determines that many users who prefer “Romantic” songs from the “1990s” also prefer “Slow-tempo” songs, then the system can automatically add “Slow-tempo” to search queries that include “Romantic” and “1990s.” The attribute “Slow-tempo” need not be displayed in any capacity to the user.

Additionally, according to further embodiments of the present invention, attributes of certain categories can be automatically populated for any given song based on different attributes of the given song. For example, a given song's particular attribute for the category “Activity” can be determined automatically based on the song's attributes for the categories “Mood” and “Tempo.” Any song that has the first-level attribute of “Happy” (associated with the category “Mood”), the second-level attribute associated of “Intense” (associated with the category “Mood Qualifier”), and the first-level attribute “High” (associated with the category “Tempo”) can automatically be given the first-level attribute “Working Out!” (associated with the category “Activity”). Furthermore, these relationships for determining additional attributes based on existing attributes can implement alternative criteria. For example, any song having the first-level attribute “Happy” or “Sad” or “Romantic” or “Philosophical” (all associated with the category “Mood”), the second-level attribute “Mellow” or “Medium” (both associated with the category “Mood Qualifier”), and the first-level attribute “Slow” or “Medium” (both associated with the category “Tempo”) can automatically be assigned the additional attribute “Just Relaxing” (associated with the category “Activity”). Any time an attribute is assigned to a particular song, a corresponding index representing the additional attribute can be added to the index record for the particular song.

Attributes that are automatically populated or determined based on additional attributes are defined herein as “derived” attributes. Similarly, a category having attributes that are based on additional attributes is a “derived” category. “Activity” category is one example derived attribute among many possible derived categories. Many different derived categories and derived attributes are possible and contemplated within the scope of the present invention.

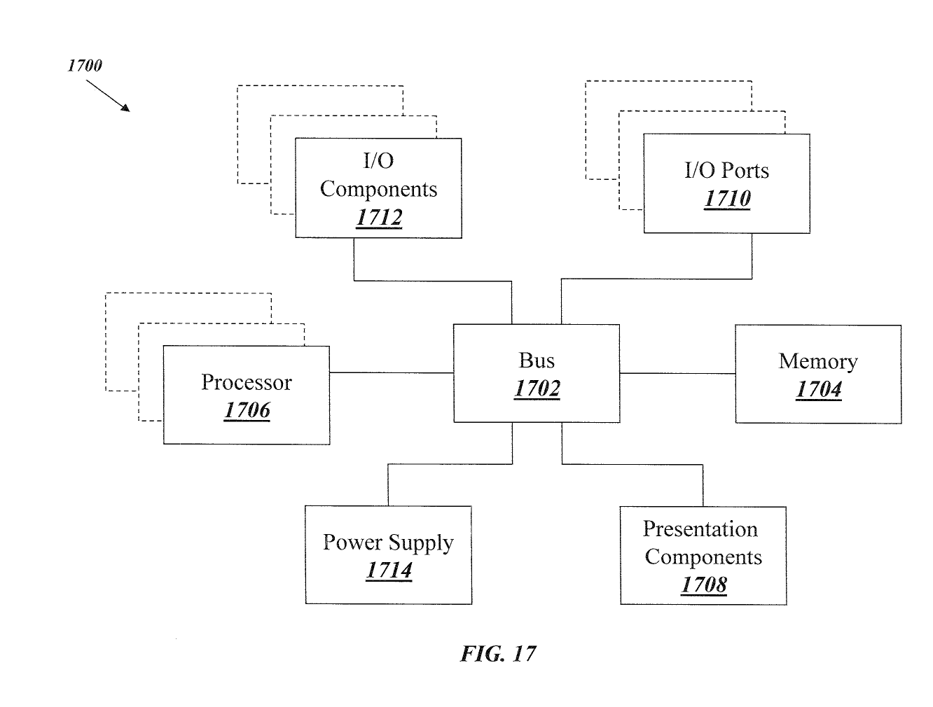

FIG. 17 illustrates computing device 1700, within an exemplary operating environment for implementing illustrative methods, systems, and a computer-readable storage medium holding instructions, of the present invention. The computing device 1700 is merely an illustrative example of a suitable computing environment and in no way limits the scope of the present invention. As such, a “computing device,” as contemplated by the present invention and represented by FIG. 17, includes a “workstation”, a “server”, a “laptop”, a “desktop”, a “hand-held device”, a “mobile device”, a “tablet computer”, or the like, as would be understood by those of skill in the art.

The computing device 1700, can include a bus 1702 that can be coupled the following illustrative components, directly or indirectly: a memory 1704, one or more processors 1706, one or more presentation components 1708, input/output ports 1710, input/output components 1712, and a power supply 1714. One of skill in the art will appreciate that bus 1702 can include one or more busses, such as an address bus, a data bus, or any combination thereof. One of skill in the art will appreciate that in some instances, multiple of these components can be implemented by a single device. Similarly, any single component can be implemented by multiple devices. As such, FIG. 17 is merely illustrative of an exemplary computing device that can be used to implement one or more embodiments of the present invention.

The computing device 1700 can include or interact with a variety of computer-readable media. For example, computer-readable media can comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 1700.

Memory 1704 can include computer-storage media in the form of volatile and/or nonvolatile memory. The memory may be removable, non-removable, or any combination thereof. Exemplary hardware devices are devices such as hard drives, solid-state memory, optical-disc drives, and the like. The computing device 1700 can include one or more processors that read data from components such as a memory 1704, various I/O components 1712, etc. Presentation component(s) 1708 present data indications to a user or other device. Exemplary presentation components include a display device, speaker, printing component, vibrating component, etc.

I/O ports 1710 can allow the computing device 1700 to be logically coupled to other devices, such as I/O components 1712. Some of the I/O components can be built into the computing device 1700. Examples of such I/O components include a microphone, joystick, recording device, game pad, satellite dish, scanner, printer, wireless device, networking device, streaming device, and the like.

Embodiments of the present invention offer numerous benefits and advantages over existing technology. Specifically, the process of navigating and exploring new media via the recommendations is based upon user-defined criteria and preferences. The criteria and preferences can be adjusted in real time to enable fine-tuning of the play lists as desired by the user. Furthermore, the system more easily facilitates exploration by displaying possible queries to users, which are defined by attributes that the user may not have previously considered. Users also are presented with the specific categories and attributes, which enables them to explore and recognize the qualities and characteristics that create enjoyable or less enjoyable experiences.

Notably, example embodiments of the present invention can separate attributes of the songs on a play list. Specifically, the attributes of a song that is playing can be visually segregated from attributes of other songs that are not playing but are nonetheless contained in the play list. This enables a user to modify the active search query as desired. For example, in the illustrative embodiment, if a user finds a particular attribute of a song enjoyable, then the user easily and intuitively can click on one of the first-level attributes located within the outer ring portion 778 to modify the active search query and command the system 100 to recommend songs that possess the desired attribute. However, if a user does not find a particular song being played enjoyable, the user can click on an attribute that is positioned outside of the outer ring portion 778, thereby commanding the system 100 to recommend a list of songs characterized by a different set of attributes than those possessed by the song being played. The users therefore are given greater control over the recommendations that they receive.

Furthermore, embodiments of the present invention provide a more convenient and intuitive organizational scheme that does not overload a user with an extraneous, unnecessary, or overburdening amount of information. Long play lists of songs can be sorted and displayed on a single screen, and organized according to categories that are familiar to users. Users can easily distinguish relatively large lists of songs based on relatively smaller quantity of attributes. This is especially beneficial given that existing systems that enable searches based on “Artist” often return hundreds of links and tens of results pages in response to a single search. Search results this large are impractical and unmanageable by users. In most instances, users do not review even a small subset of the returned results, and thus users may never find the particular songs or types of songs that he or she desires. In contrast, embodiments of the present invention provide features that allow users to find desired media, quickly, efficiently, and enjoyably.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A computer implemented display for media files, the display comprising:
a search entry field displaying an active search query defining parameters of a play list identifying one or more media files satisfying the parameters;
a playback indicator displaying information related to a selected media file from the play list; and
a plurality of category indicators each displaying a distinct media category associated with the play list;
wherein the parameters of the play list are defined by at least one attribute of a media category that is not displayed by any of the plurality of category indicators.

2. The computer implemented display of claim 1, further comprising:
one or more selectable attribute indicators each displaying an attribute of a media category associated with one of the plurality of media category indicators;
wherein selecting an attribute indicator modifies the active search query, thereby further defining the parameters of the play list and automatically updating the play list in real time;
wherein the one or more selectable attribute indicators only display attributes associated with media files in the play list.

3. The computer implemented display of claim 1, wherein the plurality of category indicators includes a mood category indicator, a genre category indicator, an era category indicator, a person category indicator, and an activity category indicator.

4. The computer implemented display of claim 1, wherein the category of the at least one attribute of a media category that is not displayed by any of the plurality of category indicators is automatically determined.

5. The computer implemented display of claim 1, further comprising one or more first-level and second-level attribute indicators each displaying an attribute of a media category associated with one of the plurality of media category indicators.

6. The computer implemented display of claim 1, further wherein the media category that is not displayed by any of the plurality of category indicators is included in a predetermined group of media categories to be displayed on the display.

7. The computer implemented display of claim 1, wherein the plurality of category indicators is arranged in a box configuration.

8. The computer implemented display of claim 1, further comprising one or more selectable first-level or second-level attribute indicators each displaying an attribute of a media category associated with one of the plurality of media category indicators, wherein selection of one of the one or more selectable first-level or second-level attribute indicators causes display of identifying information about one or more media files that possess the attribute represented by the selected one of the one or more first-level or second-level attribute indicators.

9. The computer implemented display of claim 1, wherein the plurality of category indicators includes one or more category indicators each displaying a derived media category.

10. The computer implemented display of claim 1, wherein the plurality of media category indicators includes one or more category indicators displaying an activity media category that is derived.

11. The computer implemented display of claim 2, wherein one or more of the one or more attribute indicators display derived attributes.

12. A computer implemented method, comprising:
generating an active search query for defining parameters of a first play list, the active search query being generated based on at least one user search request received through at least one input device;
identifying, using at least one processor, one or more media files satisfying the parameters of the first play list;
displaying, on at least one output device, a plurality of media categories associated with the first play list on a display;
wherein the parameters of the play list are defined by at least one attribute of a media category that is not displayed by any of the plurality of media categories.

13. The computer implemented method of claim 12, further comprising:
displaying, on the at least one output device, one or more selectable attributes each being associated with one of the plurality of media categories;
receiving a selected attribute of the one or more selectable attributes;
automatically modifying the active search query to include the selected attribute;
automatically further defining the parameters of the play list based on the modified active search query; and
automatically updating the play list and the display in real time based on the further defined parameters of the play list;
wherein all of the one or more selectable attributes are associated with media files in the play list.

14. The computer implemented method of claim 12, further comprising:
displaying, on the at least one output device, information related to a selected media file from the first play list; and
displaying, on the at least one output device, the active search query.

15. The computer implemented method of claim 12, wherein the plurality of media categories includes a mood category, a genre category, an era category, a person category, and an activity category.

16. The computer implemented method of claim 12, further comprising displaying, on the at least one output device, one or more first-level or second-level attributes each associated with one of the plurality of media categories.

17. The computer implemented method of claim 12, further comprising displaying, on the at least one output device, one or more second-level attributes each associated with one of the plurality of media categories, the one or more second-level attributes being hidden unless an associated displayed first-level attribute category is selected.

18. The computer implemented method of claim 12, wherein the plurality of categories are displayed in a box configuration.

19. The computer implemented method of claim 12, further wherein the at least one attribute of a media category that is not displayed by any of the plurality of media categories is included in a predetermined group of media categories to be displayed on the display.

20. The computer implemented method of claim 12, wherein the plurality of media categories includes one or more derived media categories.

21. The computer implemented method of claim 12, wherein the plurality of media categories includes an activity media category that is derived.

22. The computer implemented method of claim 13, wherein one or more of the one or more selectable attributes are derived attributes.

23. A computer implemented system including at least one processor, at least one input device, at least one output device, and at least one non-transitory computer readable storage device, the system comprising:
a visualization controller;
a search engine;
a play list module;
one or more displays generated by the visualization controller and output on the at least one output device for enabling exploration or recommendation of media files;
one or more active search queries generated by the search engine based on one or more user search requests received through the at least one input device, each of the one or more active search queries corresponding to one of the one or more displays; and
one or more play lists stored by the play list module, each of the one or more play lists having parameters that are defined by at least one attribute of a media category that is not displayed on the corresponding display.

24. The system of claim 23, further comprising a playback module, one or more media file databases, one or more index databases, and a client communications module.

25. The system of claim 23, further comprising a communications network.

26. The system of claim 23, wherein the media category that is not displayed by any of the plurality of media categories is automatically determined.

27. The system of claim 26, wherein the media category that is not displayed by any of the plurality of media categories is automatically determined by a method caused by at least one processor executing instructions stored on at least one non-transitory computer readable storage device, the method comprising:
receiving a search string comprising a plurality of words;
parsing the search string to generate one or more combinations of the plurality of words;
executing a search for each of the one or more combinations against each of one or more synonym dictionaries;
determining a weight for each of the one or more combinations with respect to each of the one or more synonym dictionaries based on results of the executed search for each of the one or more synonym dictionaries; and
automatically selecting, to be the media category that is not displayed by any of the plurality of media categories, a media category associated with the combination of the one or more combinations that has the highest value of weight.

28. The system of claim 27, further wherein the weight of each of the one or more combinations is based at least in part on a matching percentage between the combination and one or more entries in the one or more synonym dictionaries.

29. The system of claim 27, further wherein the search string is parsed from left to right in such a way as to form the one or more combinations of the parsed search terms, wherein each of the one or more combinations preserve original adjacency relationships in the received search string.

30. The system of claim 27, further wherein any associations between the received search string and any media categories are unknown prior to executing the method.

31. The system of claim 23, further wherein media category that is not displayed on the corresponding display is included in a predetermined group of media categories to be represented on the display.
